(19) United States
(12) Patent Application Publication
(10) Pub. No.: US 2026/0141598 A1
(43) Pub. Date: May 21, 2026

(54) MULTIMODAL LAYOUT GENERATION

(71) Applicant: GDM Holding LLC, Mountain View, CA (US)

(72) Inventors: Andrii Maksai, Zurich (CH); Blagoj Mitrevski, Zurich (CH); Claudiu Cristian Musat, Pully (CH); Effrosyni Kokiopoulou, Zurich (CH); Jesse Berent, Geneva (CH); Leandro Kieliger, Zurich (CH); Mark Patrick Collier, Zurich (CH); Aleksandr Alekseev, Écublens (CH); Berkay Döner, Chavannes-près-Renens (CH); Emanuele Nevali, Chavannes-près-Renens (CH); Omar El Malki, Saint-Sulpice (CH); Riccardo Brioschi, Lainate (IT)

(21) Appl. No.: 19/390,439

(22) Filed: Nov. 14, 2025

(30) Foreign Application Priority Data
Nov. 15, 2024 (GR) 20240100810

(51) Int. Cl. G06T 11/60; G06N 20/00

(52) U.S. Cl. CPC G06T 11/60; G06N 20/00

(57) ABSTRACT

A computer-implemented method for generating a training dataset. The method comprises receiving content comprising one or more elements, generating an element representation for each of the one or more elements by processing the content and one or more user-generated primitive element representations, generating a synthetic user-generated representation of the one or more elements based upon the one or more user-generated primitive element representations and the layout of the one or more elements in the content, and generating the training dataset based upon the synthetic user-generated representation and the content.

### CROSS-REFERENCE TO RELATED APPLICATION

This application claims the benefit under 35 U.S.C. § 119(a) of the filing date of Greek Patent Application No. 20240100810, filed in the Greek Patent Office on Nov. 15, 2024. The disclosure of the foregoing application is herein incorporated by reference in its entirety.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes systems and methods implemented as computer programs on one or more computers in one or more locations for generating a training dataset for training a machine learning model, training a machine learning model to generate content, generating content using a machine learning model, and evaluating performance of a machine learning model.

According to a first aspect there is provided a computer-implemented method for generating a training dataset. The method comprises receiving content comprising one or more elements, generating an element representation for each of the one or more elements by processing the content and one or more user-generated primitive element representations, generating a synthetic user-generated representation of the one or more elements based upon the one or more user-generated primitive element representations and the layout of the one or more elements in the content, and generating the training dataset based upon the synthetic user-generated representation and the content.

According to a second aspect there is provided a computer-implemented method for training a machine learning model to generate an output layout for content. The method comprises receiving a training dataset comprising one or more training pairs. Each training pair comprises training content comprising one or more elements arranged in a layout and a synthetic user-generated representation of the layout of the training content. The method further comprises providing data indicating the synthetic user-generated representation and data indicating the one or more elements of the training content as an input to a machine learning model to generate the output layout for the content, computing a loss value based upon the output layout for the content and data indicating the layout of the training content, and updating one or more parameters of the machine learning model based upon the loss value.

According to a third aspect there is provided a computer-implemented method for generating an output layout for content. The method comprises receiving one or more elements for the content, receiving a user-generated representation of a layout for the content, and providing, as input to a machine learning model, data indicating the one or more elements for the content and data indicating the user-generated representation of the layout to generate the output layout for the content.

According to a fourth aspect there is provided a computer-implemented method for evaluating performance of a machine learning model. The method comprises receiving evaluation content, the evaluation content comprising one or more first elements arranged in a first layout, generating, using the machine learning model, an output layout for content comprising one or more second elements arranged in a second layout, generating a first sequence of tokens based upon a logical order of the one or more first elements in the evaluation content. The first sequence of tokens comprises a token for each of the one or more first elements. The method further comprises generating a second sequence of tokens based upon a logical order of the one or more second elements in the content. The second sequence of tokens comprises a token for each of the one or more second elements. The method further comprises computing a similarity score based upon the first sequence of tokens and the second sequence of tokens and generating an evaluation metric for the machine learning model based upon the similarity score, the evaluation metric indicating the performance of the machine learning model.

There is also provided a computing system comprising one or more processors and one or more non-transitory computer-readable media storing computer-readable instructions configured to cause one or more processors to perform a method according to any one of the preceding aspects.

There is also provided one or more non-transitory computer-readable media storing computer-readable instructions configured to cause one or more computing devices to perform a method according to any one of the preceding aspects.

Particular embodiments of the subject matter described in this specification can be implemented so as to realize one or more of the following advantages.

The first aspect represents a computationally efficient method to generate a large-scale, diverse training dataset that pairs content with representations that reflect real-world representations of elements (e.g., elements sketched by a user). This method has a practical application in industry by significantly reducing time and resource costs associated with manually creating the data instead. The improved dataset also has the practical application of providing an effective means for training machine learning models to perform a task that might otherwise be infeasible or ineffective due to a lack of suitable data. For example, in e-commerce and digital advertising industries, there is a substantial and recurring need to automatically generate millions of unique, high-quality layouts. The techniques described herein provide a practical, scalable way of generating the necessary training data to automate this content generation via machine learning, thereby addressing a real-world problem.

By training the model to predict the known layout of the training content from the synthetic representation and elements of the content, the model learns to effectively map user-defined constraints to specific, structured output layouts. This training process results in a robust machine learning model that can accurately arrange content elements while respecting the spatial intent of the user. The trained model has direct practical application in many different real-world contexts where content (e.g., documents) needs to be generated in accordance with specific conditions specified by a user. This constitutes a specific, practical application of machine learning models to transform user input into a concrete, structured digital asset (i.e., via the output layout). Such a trained machine learning model underpins a tangible tool for users which significantly accelerates design processes and reduces manual data entry and implementation time.

Implementations described herein enable machine learning models to generate layouts for content including indicating a correct order for elements in the particular content whilst respecting user-defined constraints (i.e., the user-generated representation of a layout for the content). Experiments show that such machine learning models are more effective, both in terms of accuracy and in terms of time efficiency, at generating coherent content (e.g., documents). For example, on number of benchmarks, the machine learning models described herein outperform other state-of-the-art constraint-based approaches, e.g., on geometric evaluation metrics. Accordingly, computational efficiency is improved by reducing time complexity and reducing the number of inference cycles required to generate suitable content, as required by a user. At the same time, the machine learning models described herein offer a more intuitive approach to generating layouts for content (e.g., enabling integration with user experience (UX) and user interface (UI) design workflows, such as “wireframing”). The techniques therefore also represents a practical improvement to the functioning of computer systems themselves when performing the particular task of generating output layouts to render content.

Further, implementations described herein enable the generation of an extensive, representative, and diverse training dataset for training a machine learning model for the foregoing purposes. Such training datasets would otherwise be difficult or impossible to obtain, in terms of economic cost, computational cost, and time inefficiency. Specifically, the implementations described herein scale linearly with the number of user-generated primitive element representations. Thus, implementations provide a simple yet effective way to generate a suitable training dataset to unblock model training. Experimental results show that machine learning models, when trained upon such a dataset, improve performance and quality of the layouts generated by the machine learning model. Without such a method, training a machine learning model for the foregoing purposes in an effective way may not be possible.

Further, implementations described herein enable machine learning models to be evaluated according to their performance at correctly arranging elements, e.g., in a document. By taking into account the arrangement of elements (e.g., as captured by the use of sequences of tokens representing the elements) according to the intuition of reading (e.g., top-to-bottom; and left-to-right), the machine learning model may be effectively evaluated in terms of the machine learning model's “content-awareness”. Such a method provides a number of benefits. For example, once a machine learning model is trained (e.g., according to the foregoing methods), the machine learning model in many cases must be validated before being put into production use (e.g., for use by an end user). For example, the machine learning model may be required to satisfy compliance and risk management policies or meet regulatory standards. In other cases, it may be required for the machine learning model to meet certain accuracy or performance targets or satisfy user requirements. Reliability and robustness of machine learning models is also a concern. By providing an accurate method for evaluating performance of a machine learning model, a determination as to whether the machine learning model complies with requirements may be made. Accordingly, machine learning models that satisfy the evaluation may be permitted for use, providing the foregoing advantages that would otherwise not be available if the machine learning model was not evaluated and thus not permitted for use.

### BRIEF DESCRIPTION OF THE DRAWINGS

FIG. 1 depicts an example system for generating a training dataset in accordance with the techniques described herein.

FIG. 2 depicts an example system for generating a synthetic user-generated representation using user-generated primitive element representations in accordance with the techniques described herein.

FIG. 3 depicts an example training system for training a machine learning model to generate an output layout for content in accordance with the techniques described herein.

FIG. 4 depicts an example inference system for generating an output layout for content in accordance with the techniques described herein.

FIG. 5 depicts an example evaluation system for evaluating performance of a machine learning model in accordance with the techniques described herein.

FIG. 6 depicts two sets of elements in content each arranged in a logical order.

FIG. 7A depicts a first table of experimental results.

FIG. 7B depicts a second table of experimental results.

FIG. 8 depicts a first chart of experimental results.

FIG. 9 depicts a flow diagram of a method for generating a training dataset in accordance with the techniques described herein.

FIG. 10 depicts a flow diagram of a method for training a machine learning model to generate an output layout for content in accordance with the techniques described herein.

FIG. 11 depicts a flow diagram of a method for generating an output layout for content in accordance with the techniques described herein.

FIG. 12 depicts a flow diagram of a method for evaluating performance of a machine learning model in accordance with the techniques described herein.

Like reference numerals and designations in the various drawings indicate like elements.

### DETAILED DESCRIPTION

Machine learning models may be trained to generate a layout for content (e.g., a document or data indicating thereof). The content may be any type of content (e.g., an image, poster design, research paper, slideshow presentation, HTML webpage, etc.). In general, the content described herein may be any suitable type of content (e.g., a document, record, or other form of some matter). In many cases, it is desirable for a user to provide user-defined constraints for generating the layout. For example, the user may wish for known elements, i.e., images, text, etc. that are to be included in the content to be arranged in a particular layout or configuration. Machine learning models may be configured to receive such user-defined constraints as input for generating the layout. Often, user-defined constraints include complex specifications which require increased computational resources and cost (e.g., increased input size which increases computational complexity) and reduces usability (e.g., requires extensive input from the user, or requires an understanding of how to “prompt” the model correctly). It is also desirable for content (i.e., those generated according to user-defined constraints) to include elements in a semantically meaningful and correct order. In other words, it is desirable to provide a machine learning model which is “content-aware” and thus enables content to be generated (i.e., according to a desired layout) with desired structure or order. However, in many cases, existing machine learning models struggle to arrange elements in a layout correctly (e.g., struggle to infer a positional interrelationship between elements). It is therefore desirable to provide a machine learning model that overcomes such problems. Furthermore, evaluating whether a particular model arranges elements in a layout correctly is also desirable because many known approaches for evaluation do not capture whether the model includes elements in a semantically meaningful and correct order, as previously mentioned, i.e., whether the model is “content-aware”.

Machine learning models may be trained for the foregoing purpose (i.e., generating a layout for content with user-defined constraints). Machine learning models often require large amounts of training data to be effectively trained. That is, training machine learning models for the foregoing purpose may be difficult because suitable training data is not readily available and is otherwise difficult to obtain. For example, collecting training data from human annotators is very costly, requires a significant amount of time, has limited scalability, and can introduce bias, errors, or result in low quality data. It is thus desirable to provide a method for generating a training dataset effectively.

The present disclosure includes techniques to enable content (e.g., documents) to be generated that adhere to a user-defined layout whilst reducing computational complexity and increasing usability. Furthermore, techniques described in the present disclosure can enable machine learning models to be trained to be “content-aware”, i.e., trained to arrange elements for the content in a semantically meaningful and correct order, and demonstrate state of the art performance on a number of benchmarks. Techniques are also described to generate an extensive and diverse training dataset for training machine learning models for the foregoing purpose. There is also described techniques to evaluate the performance machine learning models trained according to the aspects described herein, in addition to other machine learning models, with respect to their ability to arrange elements in a semantically meaningful and correct order.

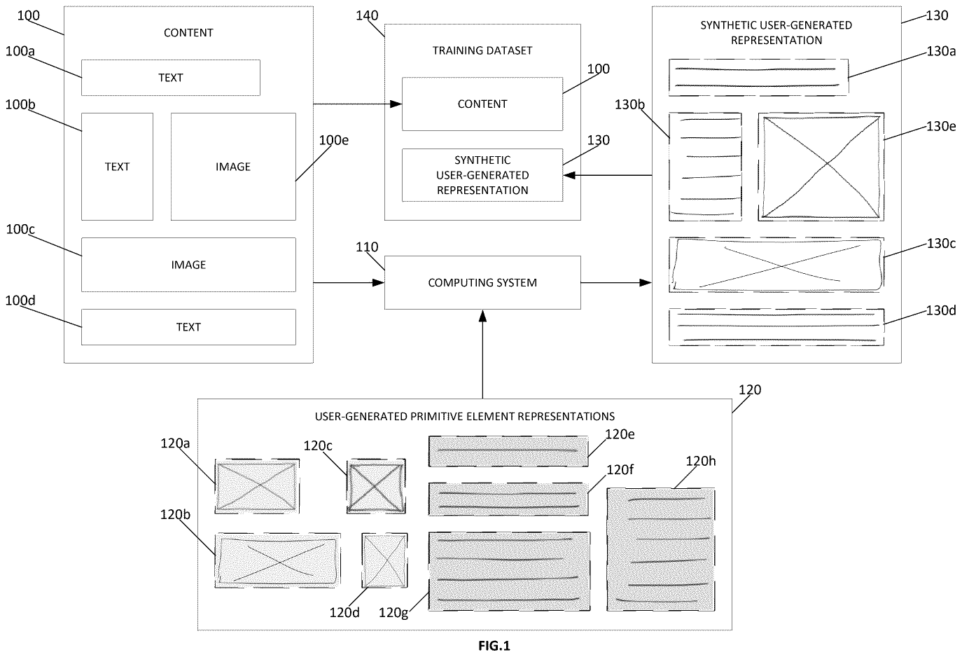

FIG. 1 depicts an example system for generating a training dataset 140 in accordance with the techniques described herein.

The example system implements a computer-implemented method for generating the training dataset. The method may comprise receiving content 100 comprising one or more elements 100a-100e, generating an element representation 130a-130e for each of the one or more elements 100a-100e by processing the content 100 and one or more user-generated primitive element representations 120a-120h, generating a synthetic user-generated representation 130 of the one or more elements 100a-100e based upon the one or more user-generated primitive element representations 120a-120h, and generating the training dataset 140 based upon the synthetic user-generated representation 130 of the one or more elements 100a-100e and the content 100.

Generating the synthetic user-generated representation 130 of the one or more elements 100a-100e based upon the one or more user-generated primitive element representations 120 may be further based upon a layout of the one or more elements 100a-100e in the content 100. For example, the layout may be the spatial arrangement of the text 100a, 100b, 100d and/or the images 100c, 100e in the content 100. The layout may be represented by layout data (not depicted). The computing system 100 may process the layout data to generate the synthetic user-generated representation 130, as discussed above. That is, the example system may implement another computer-implemented method for generating the training dataset 140. The method may comprise receiving the content 100 comprising the one or more elements 100a-100e. The method may further comprise generating the element representation(s) 130a-130e for each of the one or more elements 100a-100e by processing the content 100 and the one or more user-generated primitive element representations 120a-120h. The method may further comprise generating a synthetic user-generated representation 130a-130e of the one or more elements 100a-100d based upon the one or more user-generated primitive element representations 120a-120h and the layout (or layout data indicative thereof) one or more elements 100a-100d in the content 100. The method may further comprise generating the training dataset 140 based upon the synthetic user-generated representation 130 and the content Generating the training dataset 140 may include generating one or more training examples for each content received. The training examples may each include the respective content 100 and the synthetic user-generated representation 130 of the element(s) 100a-100e of the respective content 100.

For example, content 100 such as a document may be received comprising a text element 100a, 100b, 100d, such as a heading, at a top-left portion of the document and an image element 100c, 100e, such as a logo, at a bottom-right portion of the document. The document may be processed (e.g., to extract the text element 100a, 100b, 100d and the image element 100c, 100e from the document) alongside one or more user-generated primitive element representations 120 using any suitable means (e.g., one or more functions implemented using one or more processors, such as function(s) of the computing system 110). The user-generated primitive element representations 120a-120h may each be a representation of an element (e.g., a text element or image element analogous to the text or image element of the document; an abstract or hypothetical element) generated by a user. In implementations, the user-generated primitive element representations 120a-120h are images that are collected from and/or generated by human annotators and which represent particular elements (e.g., a rectangle with a cross to indicate an image element, as depicted for example user-generated primitive element representations 120a-120d). These known user-generated primitive element representations 120a-120h may thus be leveraged to generate the synthetic user-generated representation 130 for, e.g., a new document. The elements 100a-100e extracted from the document 100 may be the elements 100a-100e of the document per se (i.e., including the text 100a of the heading and the logo 100e, as depicted in FIG. 1) or may be, for example, a representation of the geometric shape of the respective elements 100a-100d in the document 100, such as a bounding box representation (see the element representations 130c, 130e in FIG. 1). That is, any suitable pre-processing operation may be performed on the elements 100a-100e extracted from the document 100 prior to generating the element representation 130a-130e.

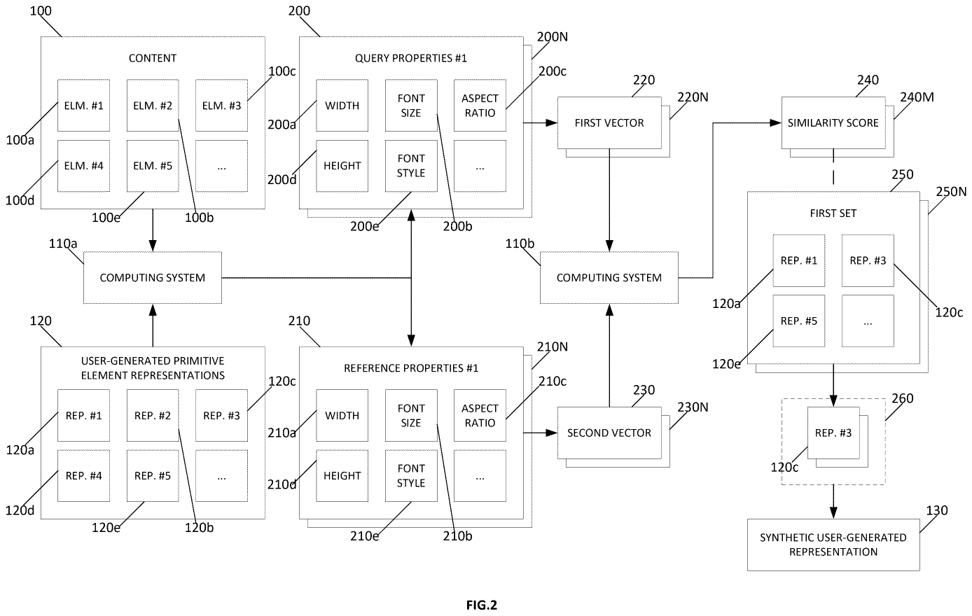

Accordingly, the element representation 130 for some given content may be generated for each of the one or more elements 100a-100e extracted from the content 100. The element representations 130a-130h may each indicate a synthetic user-generated representation of the respective element. In other words, the synthetic user-generated representation of the respective element may simulate or represent what a user-generated representation of the respective element would look like. For example, the synthetic user-generated representation of the respective element may represent a user-generated (e.g., handwritten sketch or wireframe schematic, such as those depicted in FIG. 1) representation of the respective element. For example, the synthetic user-generated representation of a respective element may include one or more horizontal wavy lines to indicate the text element and a rectangle with a cross inside of it to indicate the image element. The term “synthetic” user-generated representation of an element in this context means that a user (i.e., a natural person) did not necessarily generate a representation for the particular element being represented. For example, the synthetic user-generated representation for a particular element may be, or may be based upon, a user-generated representation that was prepared by a user to represent a different element but which may also be purposed to represent the particular element. That is, the user may generate, in the real-world (e.g., draw, sketch, etc.), primitive representations of example element(s). The primitive representations may include an image depicting an example text element or an example image element. The primitive representation(s) may be repurposed to generate a representation of a particular element from the content 100 to generate the training dataset 140. The primitive representations may be selected intelligently (e.g., according to properties thereof, such as width, height, font size, font style, etc. as discussed with reference to FIG. 2). The primitive representations may be modified (e.g., resized) to accurately reflect the element they are intended to represent.

The synthetic user-generated element representation (e.g., 130a-130e) may be a user-generated element representation that has undergone some further processing (e.g., by the computing system 110). For example, the further processing may make the synthetic user-generated element representation more suitable for representing the particular element. In a specific example, the further processing may include resizing and/or cropping. The synthetic user-generated element representations may simulate design patterns or techniques used for user-experience (UX) and/or user-interface (UI) design. Subsequently, the synthetic user-generated representation 130 of the layout for the content 100 (e.g., a simulation of a user-generated representation of the layout of the content 100 as a whole) may be generated. For example, the synthetic user-generated representation 130a-130e of the text element(s) 100a, 100b, 100d and the image element(s) 100c, 100e may be combined together, according to the layout of the elements of the content 100, such that they represent the layout of the original content. That is, in the foregoing example, the synthetic user-generated representation 130 may include an element representation (e.g., indicating the one or more horizontal wavy lines to represent text) at a top-left portion of the synthetic user-generated representation and another element representation (e.g., indicating the rectangle with the cross inside to represent an image) at a centre-right portion of the synthetic user-generated representation 130, as depicted in FIG. 1. Such a synthetic user-generated representation 130 may simulate the layout of the content 100 having the text element 100a at a top-left portion and an image element 100e at a centre-right portion. The exact position of each of the elements 100a-100e and representations 130a-130e thereof in the content 100 and the synthetic user-generated representation 130 respectively may be determined based upon the layout of the elements 100a-100e in the original content (e.g., based upon data indicating the layout). Such layout data may be part of the content 100 itself or provided separately in any usual way (e.g., incorporated or unincorporated metadata). For example, such layout data may specify 2D coordinates for the position of both the text element 100a and the image element 100e in the content 100.

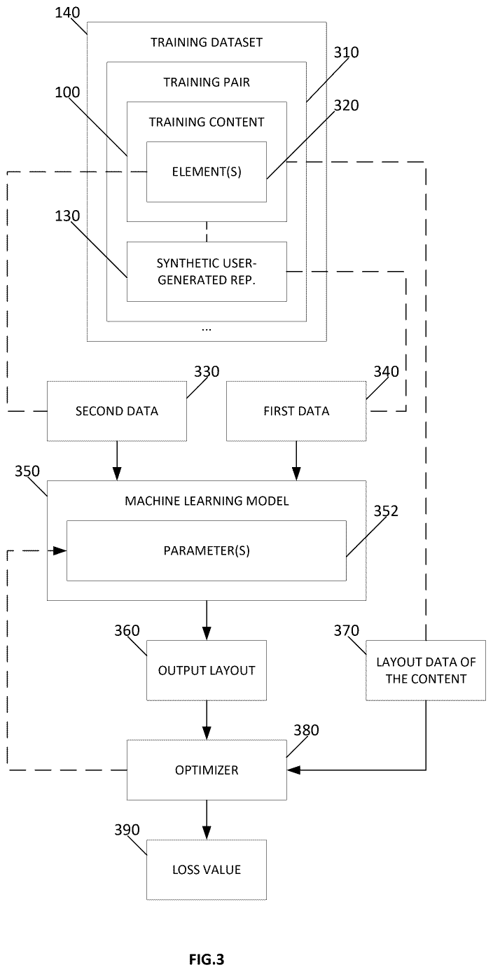

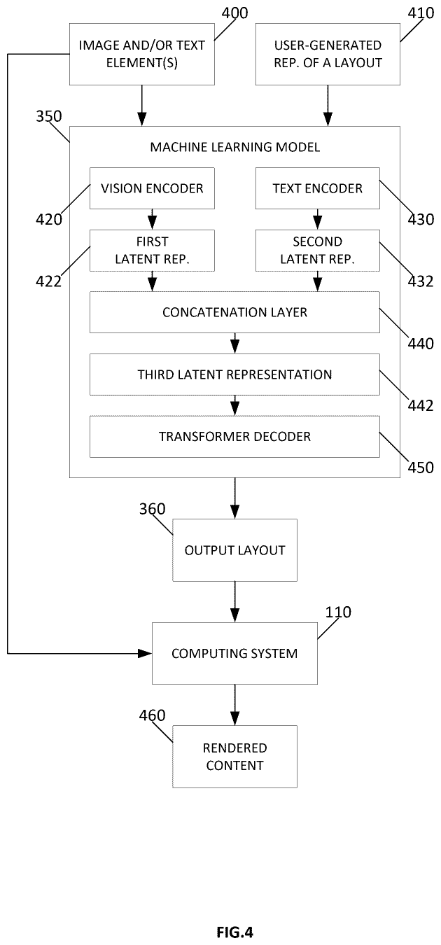

Once a synthetic user-generated representation 130 has been generated for some content 100 (e.g., a given document) a training dataset 140 may be generated. That is, the synthetic user-generated representation 130 may be paired (e.g., logically associated in some way) with the content 100 and included in the training dataset 140 as a training pair. It will be appreciated that the training pair may include any data derivable from the content 100 (i.e., including, but not limited to, the document 100 itself). For example, the training pair may include the set of elements 100a-100e of the content 100, the layout of the content 100, or any other property or data derivable from the content 100, thus enabling many different types of machine learning models to be trained. The method described above may be repeated any number of times for any number of content (e.g., any number of “example documents”). By generating synthetic user-generated representations 130 in this way, an extensive, complete, and diverse training dataset 140 may be generated. Such a training dataset 140 may otherwise be difficult or impossible to obtain. The training dataset 140 may subsequently be used to train a machine learning model to generate a layout for some elements to be rendered into content. The trained machine learning model may subsequently be used to generate content, e.g., a document, with element arranged in a particular (i.e., user-specified) layout, guided by user-generated representations as input. Experiments demonstrate that machine learning models trained according to a training dataset 140 generated in this way demonstrate state of the art performance on standard benchmarks. Further detail regarding training and inference of a machine learning model, as discussed above, is provided below with reference to FIG. 3 and FIG. 4 respectively.

In some implementations, the method may comprise receiving the one or more user-generated primitive element representations 120, each user-generated primitive element representation 120a-120h indicating at least a portion of an exemplary element, each user-generated primitive element representation 120a-120h generated by a human annotator.

That is, the one or more user-generated primitive element representations 120a-120h may be pre-defined and may be provided in advance of generating the synthetic user-generated representation 130. The exemplary element may be one or more previously provided (e.g., to the human annotator before the training dataset 140 is generated) model elements of some content. For example, a set of documents may be provided, each document in the dataset comprising one or more exemplary elements. The human annotator(s) may generate a primitive element representation for one or more of the exemplary elements of the documents in the set. In other words, a set of user-generated representations may be received prior to generating the element representation. The purpose of the user-generated primitive element representations 120 is to serve as basis for representing the elements 100a-100e of the content 100. The user-generated primitive element representations may have been (i.e., prior to generating the training dataset) obtained to simulate exemplary elements, or portions thereof. Thus, the composition of a candidate content 100 for the training dataset 140 may be modelled according to a composition of user-generated representations 120a-120h of one or more of these exemplary elements. By generating the element representation for each of the one or more elements 100a-100e in this way, manually generating a unique element representation (e.g., generated by a user rather than automatically, which can take a substantial amount of time) for each particular element 100a-100e in the content 100 is not required, thus reducing the overall time and physical resources taken to generate an extensive, complete, and diverse training dataset 140.

In some implementations, the method may further comprise generating, by the human annotator, the one or more user-generated primitive element representations 120a-120h.

That is, the method can also include the step of generating the primitive representations 120. For example, a human annotator can generate (e.g., draw on a computing device such as a tablet, or on paper) the primitive representations 120 for processing by a computer. In some examples, the primitive representations 120 are based upon existing content (e.g., reference documents). In other examples, the primitive representations 120 are generated without reference to existing content (e.g., devised and fabricated by the annotator from scratch). In implementations, the primitive representations 120a-120d for exemplary image elements were represented by a rectangle box including a cross in the center and the primitive representations 120e-120h for exemplary text elements were represented by one or more horizontal wavy lines. Once generated, the primitive representations 120 may be provided for use (i.e., for generating the element representations 130a-130e, and thus the synthetic user-generated representation 130).

The method implemented by the system depicted in FIG. 1 may further include data pre-processing. That is, the method may further comprise processing the content 100 to identify the one or more elements. In some examples, the method may comprise processing the content 100 using an optical character recognition (OCR) model to identify text element(s) in the content 100. In some examples, the method may comprise cropping the content prior to processing the content using the OCR model. In some examples, the method comprises processing the content to identify one or more attributes for each of the elements 100a-100e. In such examples, the extracted attributes (e.g., font size and font colour) for each of the elements 100a-100e may be used to generate the training dataset (e.g., used to select which of the user-generated primitive element representations 120a-120h are used to generate the synthetic user-generated representation 130. In some examples, the OCR model may extract the attributes for each of the elements 100a-100e. In some examples, processing the content 100 to identify the one or more elements may include (i) identifying a portion of the content (e.g., a bounding box portion) and (ii) extracting a foreground of the content in the portion and/or (iii) extracting a background of the content in the portion. The method may comprise (iv) providing the foreground and/or background portion as one of the one or more elements 100a-100e.

In some implementations, the user-generated primitive element representations 120a-120h are stored in a space-partitioning data structure (e.g., a k-dimensional (KD)-tree) and retrieved from the space-partitioning data structure upon, for example, querying for a primitive representation using the query properties 200. Using such a tree-like data structure in this specific context was computationally more efficient (logarithmic complexity) than, for example, querying the full set of primitive representations 120. A further advantage of using such a data structure is the avoidance of the need to pre-compute centroids (e.g., cluster centroids for querying for primitive representations 120 matching a respective element 100a-100e). This means that the set of primitive representations 120 may be updated quickly and efficiently.

FIG. 2 depicts an example system for generating a synthetic user-generated representation using user-generated primitive element representations in accordance with the techniques described herein.

In some implementations, processing the content 100 and the one or more user-generated primitive element representations 120 comprises determining, for each of the one or more elements 100a-100e, one or more query properties 200 for the element (i.e., query properties 200-200N when considering query properties for each of the element(s) 100a-100e collectively), determining, for each of the one or more user-generated primitive element representations 120a-120h, one or more reference properties 210 (i.e., reference properties 210-210N when considering reference properties for each of the primitive representations 120a-120e collectively) and identifying, for each of the one or more elements 100a-100e, a first set 250 of the one or more user-generated primitive element representations 120 (i.e., first sets 250-250N when considering first sets for each of the one or more elements 100a-100e collectively) based upon the respective one or more query properties 200 and the one or more reference properties 210 for each of the one or more user-generated primitive element representations 120. In such implementations, generating a respective element representation for each of the one or more elements 100a-100e is based upon the respective first set 250-250N of the one or more user-generated primitive element representations 120a-120e. For simplicity, FIG. 2 is depicted with only five primitive representations 120a-120e compared to the eight primitive representations 120a-120h depicted in FIG. 1.

In some implementations, the query properties 200 and the reference properties 210 each including one or more of: a width 200a, 210a, a height 200d, 210d, a font size 200b, 210b, font style 200e, 210e, or an aspect ratio 200c, 210c of the respective element 100a-100e or user-generated primitive element representation 120a-120e.

That is, each of the one or more elements 100a-100e of the content 100 may correspond to (or possess) one or more properties 200a-200e. Likewise, each of the user-generated primitive element representations 120a-120h may also correspond to (or possess) one or more properties 210a-210e. Accordingly, a first set 250 (i.e., candidate set of primitive representations 120a, 120c, 120e, . . . ) may be identified including those primitive representations 120a, 120c, 120e that have properties (“reference properties”) which match properties (“query properties”) of the respective element. Accordingly, an element representation for a respective element may be generated using one or more of those matching primitive representations (e.g., 120c) part of the first set 250. For example, the image element as previously described may have a width 200a of 128 px, a height 200d of 64 px, and an aspect ratio 200c of 2:1. A candidate set (i.e., the first set 250) of the primitive representations 120 may be identified by matching one or more of the user-generated primitive element representations 120a-120e being (or approximating), e.g., 128 px wide, 64 px high, and/or having an aspect ratio of 2:1. It will be appreciated that any number of properties 200, 210 may be a match to identify the first set 250. That is, in some examples, only an aspect ratio of 2:1 may be required for one of the user-generated primitive element representations 120 to be included in the first set 250. In other examples, a plurality of properties must be a match for inclusion in the first set 250. The matching may be identical or approximate (“fuzzy”) matching. As mentioned, the primitive representation 120a-120h indicates at least a portion of an exemplary element. Accordingly, for a respective element, the element representation may be generated using two or more of the primitive representations 120 where the primitive representations 120 indicate a portion of an exemplary element. However, in other examples (i.e., where the primitive representation 120 indicates a whole exemplary element), the element representation may be generated using only one of the primitive representations 120a, 120c, 120e in the first set 250. In some examples, the type of property is determined based upon a type of the respective element. For example, the type of the respective element may be either a text element or an image element. That is, the properties of the element 100a-100e and the properties of the primitive representation 120a-120e may be assessed according to an appropriate subset of properties 200a-200e, 210a-210e depending upon whether the respective element is, e.g., an image element, a text element, etc. By generating a respective element representation in this way (i.e., based upon those primitive representations 120a, 120c, 120e part of the first set 250), the respective element representation may accurately indicate or simulate a user-generated representation of an element (and thus accurately indicate or simulate a user-generated representation of the content 100 as a whole, such as via the synthetic user-generated representation 130).

In some implementations, generating the respective element representation for each of the one or more elements 100a-100e based upon the respective first set 250 comprises selecting one of the user-generated primitive element representations 120 from the respective first set 250 at random. The selection for the first element 100a is indicated in FIG. 1 as the third user-generated primitive element representation 120c.

For example, for a first element 100a and for generating a first element representation 130a thereof, a first set 250 comprising a first, second, and third user-generated primitive representation 120a, 120c, 120e may be identified. In this example, one of the first, second, and third primitive representation 120a, 120c, 120e may be randomly identified (e.g., using any suitable method, such as pseudorandom logic). In this example, the second primitive representation 120c may be selected and used as the user-generated primitive element representation 120c for generating the particular element representation of the first element 100a. The same approach may be taken for each of the other elements 100b-10e (i.e., for generating each element representation 130a-130e). In this way, diversity and variation may be introduced to the training dataset by generating different element representations (hence different synthetic user-generated representations) by incorporating randomness. This enhances the training dataset 140; many different variations of training examples improves generalization and accuracy of machine learning models trained based thereon.

In some implementations, the one or more query properties 200 for the respective element is represented by a first vector 220 comprising one or more first normalized values, each first normalized value corresponding to a different one of the respective query properties 200. In such implementations, the one or more reference properties 210 for the respective user-generated primitive element representation 120a-120e is represented by a second vector 230 comprising one or more second normalized values, each second normalized value corresponding to a different one of the respective reference properties 210.

In some implementations, identifying, for each respective element 100a-100e of the one or more elements, the first set 250 of the one or more user-generated primitive element representations 120 based upon the respective one or more query properties 200 and the one or more reference properties 210 for each of the one or more user-generated primitive element representations 120 (e.g., multiple first sets 250-250N for multiple primitives) comprises determining the first vector 220 for the respective element 100a-100e, determining, for each of the user-generated primitive element representations 120a-120e, the second vector 230 for the respective user-generated primitive element representation 120a-120e, computing, for each of the user-generated primitive element representations 120a-120e, a corresponding similarity score 240 (e.g., multiple similarity scores 240-240M) indicating a degree of similarity based upon the first vector 220 and the respective second vector 230, and identifying the first set based upon the one or more similarity scores. For example, the first vector 220 corresponding to the first element 100a may be determined and used to compute a respective similarity score 240 by comparing the first vector 220 to each respective second vector 230-230N determined for each of the primitive representations 120. In this example, each first vector 220-220N may be compared in the same way to generate a plurality of respective similarity scores 240. These scores 240-240M may be used to inform the first sets 250-250N.

In some implementations, the similarity score 240 is a Euclidean Distance score.

For example, for a respective element 100e of the content 100, such as the image element as previously described, the one or more query properties 200 may be represented by a vector such as [0.8, 0.5] where 0.8 represents a normalized value corresponding to a width property 100a of the respective element 100e and where 0.5 represents a normalized value corresponding to an aspect ratio property 200c of the respective element 100e. In this example, for a first user-generated primitive element representation 120a, the one or more reference properties 210 may be represented by a vector such as [0.7, 0.5] where 0.7 represents a normalized value corresponding to a width property 210a of the first user-generated primitive element representation 120a and where 0.5 represents a normalized value corresponding to an aspect ratio property 210c of the first user-generated primitive element representation 120a. In this example, a non-normalized value for the width property 210a may be 128 and a non-normalized value for the aspect ratio 210c may be a numeric value representing an aspect ratio of 2:1. Accordingly, a similarity score (i.e., for the pair of the respective element 100e and the first user-generated primitive element representation 120a) may be computed using first and second vectors [0.8, 0.5] and [0.7, 0.5]220, 230. In implementations, a Euclidean Distance score was used, however other similarity scores are envisaged (e.g., cosine similarity or Manhattan Distance). Accordingly, the first user-generated primitive element representation 120a may or may not be included in the first set 250 depending upon its corresponding similarity score. To identify the first set 250, this process may be repeated for each element 100a-100e of the content 100 with respect to every primitive representation 120a-120e.

In some implementations, identifying the first set 250 based upon the one or more similarity scores 240-240N comprises selecting a predetermined number of the user-generated primitive element representations 120 for inclusion in the first set 250.

For example, the predetermined number may be 3. Thus, in this example, the first set 250 may only comprise 3 different user-generated primitive element representations 120a, 120c, 120e. In this way, the number of candidate primitive representations 120 may be significantly reduced, controlling variance when randomly selecting a primitive representation 120a, 120c, 120e from the first set 250 to generate an element representation (e.g., selecting primitive representation 120c).

In some implementations, each of the selected primitive user-generated representations 120a, 120c, 120e correspond to a similarity score 240 indicating a higher degree of similarity than any similarity score 240 corresponding to a user-generated primitive element representation 120b, 120d not selected for inclusion in the first set 250. For example, primitive representations #1, #3, and #5 120a, 120c, 120e may have a higher degree of similarity to element #1 100a with respect to their respective reference properties 210 than primitive representations #2 and #4 120b, 120d.

As a specific example, for a set of 20 different user-generated primitive element representations 120, the set of corresponding similarity scores with respect to a given element (e.g., 100a) may be: [13.0, 9.75, 10.26, 4.0, 3.45, 7.17, 8.0, 7.09, 16.36, 9.99, 18.26, 4.78, 9.09, 1.07, 1.25, 14.03, 11.79, 19.99, 13.79, 17.75]. In the previous example where the predetermined number is 3, the first set 250 may include 3 different user-generated primitive element representations 120. That is, in a specific example, the first set 250 may include a different primitive representation 120a-120e for each one of the following similarity scores 240 from the set of 20 for the given element: [1.07, 1.25, 3.45]. That is, in this example (i.e., using Euclidean Distance), the similarity scores 240-240M indicating the highest degree of similarity are 1.07, 1.25, 3.45, and 4.0. Accordingly, the user-generated primitive element representations 120a, 120c, 120e corresponding to these similarity scores may be included in the first set 250. It will be appreciated that for other types of similarity metric (e.g., cosine similarity), a higher similarity score 240 indicates a higher degree of similarity, whereas for other types of similarity metric (e.g., Manhattan Distance and Euclidean Distance), a higher similarity score indicates a lower degree of similarity.

FIG. 3 depicts an example training system for training a machine learning model to generate an output layout for content in accordance with the techniques described herein.

The example system of FIG. 3 implements a computer-implemented method for training a machine learning model 350 (e.g., neural network, such as an attention-based neural network) to generate an output layout 360 for content (e.g., analogous to content depicted in FIG. 1, as rendered according to the output layout 360). The method may comprise receiving a training dataset (e.g., the training dataset 140 described with reference to FIG. 1) comprising one or more training pairs 310. In such implementations, each training pair comprises training content 100 comprising one or more elements 320 arranged in a layout and a synthetic user-generated representation 130 of the layout of the training content 100. The method may further comprise providing first data 340 indicating the synthetic user-generated representation and second data 330 indicating the one or more elements 320 of the training content as an input to a machine learning model 350 to generate the output layout 360 for the content. The method may further comprise computing a loss value 390 based upon the output layout 360 for the content and data 370 indicating the layout of the training content 100 (e.g., layout data). The loss value 390 may be computed by an optimizer 380 (e.g., optimization algorithm implemented by the computing system 110). The method may further comprise updating one or more parameters 352 of the machine learning model 350 based upon the loss value 390.

For example, a training dataset (e.g., a training dataset 140 generated according to the techniques described above) may be received. The training dataset 140 may comprise one or more pairs 310 (i.e., including content 100 such as a document and a corresponding synthetic user-generated representation 130, as previously described). A machine learning model 350 may be configured to receive, as input, data 340 indicating the synthetic user-generated representation and data 330 indicating one or more elements 320 of the content 100. Accordingly, the machine learning model 350 may be trained to “reconstruct” or “predict” the layout of the content 100 using the synthetic user-generated representation 130 and the elements 320 of the training content 100. That is, the machine learning model 350, in response to the input 330, 340, may be configured to generate the output layout 360 for the content. The loss value 390 may be computed in any suitable way (e.g., mean squared error) based upon the output layout 360 (i.e., the prediction of the machine learning model 350) and the data 370 indicating the layout for the training content 100 (i.e., ground truth data). The data 370 indicating the layout for the training content 100 may be data analogous to or approximating the output data 360 (layout) generated at inference, such as in the form of comparable Protobuf data, as described below.

In some implementations, providing the data 330 indicating the one or more elements 320 of the training content 100 as the input to the machine learning model 350 comprises determining an element input data item (not depicted) for each of the one or more elements 320 of the training content 100 based upon the data 330 indicating the one or more elements 320 and generating the input (i.e., including 330, 340) to the machine learning model 350 by randomly ordering the one or more element input data items in the input.

That is, during training, the order in which elements 320 or “assets” appear in the input of the machine learning model 350 may be randomized. Likewise, the same may be applied to any other input to the machine learning model 350 (e.g., the synthetic user-generated representation 130 itself or an instruction (e.g., a system prompt; not depicted), as described below). For example, for an input comprising text element A 100a, text element B 100b, image element C 100c, text element D 100d, and image element E 100e, the input to the machine learning model 350 may be structured (e.g., prior to a forward pass) such that the order of elements A to E, or latent representations thereof, are randomized. The random ordering may be achieved in any suitable way (e.g., using pseudorandom numbers). This practice serves the purpose of preventing the machine learning model 350 from exploiting and relying upon, for predictions, common orders in the input sequence that may be used to infer the order that elements are supposed to be arranged. A machine learning model 350 trained in this way is agnostic to the order in which input elements are provided at inference meaning that the machine learning model 350 maintains a high level of accuracy even when, in practice at inference time, elements are provided in a random order for structured arrangement.

FIG. 4 depicts an example inference system for generating an output layout for content in accordance with the techniques described herein.

The example system of FIG. 4 implements a computer-implemented method for generating an output layout 360 for content 460. The method may comprise receiving one or more elements 400 for the content 460, receiving a user-generated representation 410 of a layout for the content 460, and providing, as input to a machine learning model 340, data indicating the one or more elements 400 for the content 460 and data indicating the user-generated representation 410 of the layout to generate the output layout 360 for the content 460.

In some implementations, the method may further comprise generating, based upon the output layout 360 and the one or more elements 400 for the content, the content 460. The generating may be performed by the computing system 110 previously described.

That is, a machine learning model consistent with the machine learning model 350 described above may be provided for generating an output layout 360 (e.g., data representing or indicative thereof) the layout for the content 460 (i.e., inference). In other words, the layout for the content 460 may be inferred based upon elements 400 for the content (e.g., elements for a document, such as text elements, that a user wishes to arrange in a particular layout in the document) and a user-generated representation 410 of the layout (e.g., a sketch generated by a user indicating the particular layout). The inputs 400, 410 (i.e., the user-generated representation of the layout and the elements) to the machine learning model 350 may be received in any usual way (e.g., transmitted over a network in response to input from a user via a client device). In some examples, the content 460 itself (e.g., a document) may be generated by, e.g., “recomposing” the elements according to the output layout 360 for the content 460. In other words, the content 460 may be generated using the output layout 360 and the one or more elements 400. In some examples, the content 460 is an image such as an SVG including the one or more elements 400 arranged in the layout 360. That is, the output layout 360 may specify or indicate positions (and attributes) for each of the elements 400 (e.g., with respect to a 2D plane) and one or more post-processing functions (e.g., of the computing system 110) may be configured to arrange the one or more elements 400 according to the layout indicated by the specified positions to generate data indicating the content 460. The process of generating the content based upon the element(s) 400 according to the output layout 360 is referred to herein as “rendering”. The output layout 360 thus functions as a set of specific, concrete instructions (e.g., including coordinates or element identifiers) that control the operation of a downstream computing process (i.e., to render the content 460) and act as machine-readable instructions.

In some implementations, the method may further comprise receiving (not depicted) an instruction (e.g., system instruction or prompt) indicating one or more properties for the layout 360 of the content. In such implementations, generating the output layout 360 using the machine learning model 350 is further based upon the instruction indicating the one or more properties.

That is, a user may provide additional instructions (or “conditions”) to the machine learning model 350 that may cause the machine learning model 350 to generate an output layout 360 with particular properties (e.g., properties for particular elements, such as name identifiers or coordinates for the particular elements). Accordingly, the machine learning model 350 may take into account additional (supplemental) information thus improving the accuracy of the final output layout 360 for the content 460.

The machine learning model 350 may have been trained according to any of the techniques described above (e.g., those described with reference to FIG. 3).

In some implementations, such as those discussed above with reference to training dataset generation, training, and/or inference, the user-generated representations 130a-130e are a handwritten sketch or wireframe schematic (e.g., analogous to the practical application of sketches or schematic drawings in UI/UX design workflows).

That is, the user-generated representations 130a-130e may be a basic or simple visual indication of a structure or layout of the respective content, as produced by a human. Such user-generated representations may serve as a design blueprint for the layout of the content 100 and include indications for the position and type of essential elements (e.g., images or text) in the content. A wireframe schematic may in some examples be characterised as a visual guide representing a skeletal framework for the content 460 and elements to be arranged therein.

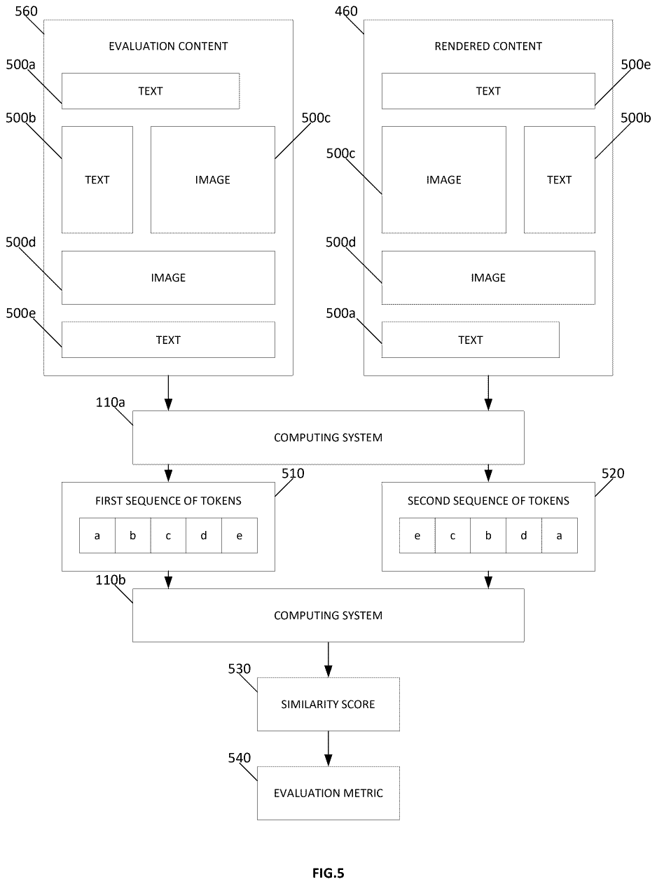

FIG. 5 depicts an example evaluation system for evaluating performance of a machine learning model in accordance with the techniques described herein.

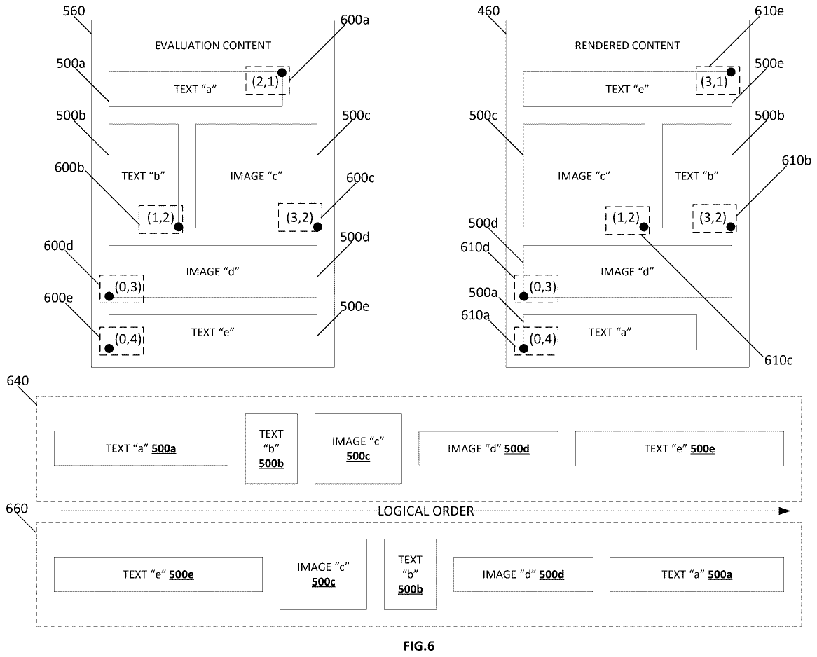

The example system depicted in FIG. 5 implements a computer-implemented method for evaluating performance of a machine learning model 350. The method may comprise receiving evaluation content 560, the evaluation content 560 comprising one or more first elements 500a-500e arranged in a first layout (e.g., the particular arrangement of elements 500a-500e in the evaluation content 560). The method may comprise generating (not depicted), using the machine learning model 350, an output layout (e.g., analogous to the output layout 360 described with reference to FIG. 3 and FIG. 4) for content 460 comprising one or more second elements 500a-500e arranged in a second layout (e.g., the particular arrangement of elements 500a-500e). That is, in the particular example depicted in FIG. 5, the first and second elements are the same set of elements. In some examples, the sets of first elements and second elements may differ. The method may comprise generating a first sequence of tokens 510 based upon a logical order of the one or more first elements 500a-500e in the evaluation content 560. The logical order may be any order of the elements 500a-500e in their arrangement in the evaluation content 560. A specific example of a logical order is described below with reference to FIG. 6. In such implementations, the first sequence of tokens 510 comprises a token (i.e., five tokens “a”, “b”, “c”, “d”, and “e” in the specific example depicted in FIG. 5) for each of the one or more first elements 500a-500e (e.g., “a” corresponding to element 500a). The method may further comprise generating a second sequence of tokens 520 based upon a logical order of the one or more second elements 500a-500e in the content 460. In such implementations, the second sequence of tokens 520 comprises a token (i.e., five tokens “e”, “C”, “b”, “d”, and “a” in the specific example depicted in FIG. 5) for each of the one or more second elements 500a-500e (e.g., “a” corresponding to element 500a). The method may further comprise computing a similarity score 530 based upon the first sequence of tokens 560 and the second sequence of tokens 460. The method may further comprise generating an evaluation metric 540 for the machine learning model (not depicted in FIG. 5; for example, analogous to the machine learning model 350 described with reference to FIG. 3 and FIG. 4 for generating output layouts), based upon the similarity score 530. The evaluation metric 540 may indicate the performance of the machine learning model. That is, the evaluation metric 540 may be generated to evaluate the performance of the machine learning model that generated the output layout for arranging the elements 500a-500e in the rendered content 460.

In some implementations, the similarity score 530 is a Levenshtein Distance score. The type of similarity score 530 used to generate the evaluation metric 540 may be any suitable measure of similarity (e.g., Euclidean Distance or cosine similarity). The similarity score 530 may depend upon the type of the tokens (e.g., for text tokens, a Levenshtein Distance may be more suitable; e.g., for numeric tokens, a Euclidean Distance or cosine similarity may be more suitable).

That is, evaluation content 560 (e.g., a test document, analogous to the documents previously described) may be received for evaluating a machine learning model. In some examples, the machine learning model for evaluation is the machine learning model 350 previously described for generating an output layout 360. In other examples, the machine learning model for evaluation is another machine learning model (e.g., a different type of machine learning model with a different architecture, trained in a different way, etc.) for generating content (e.g., for generating documents). The method, as described, is for evaluating whether the machine learning model that generated an output layout for rendering content 460 is “content-aware”, i.e., whether the machine learning model arranges elements 500a-500e in a semantically meaningful and correct order. In the proceeding examples, the evaluation content 560 may be considered to serve as ground truth data (e.g., a benchmark) for the machine learning model, where the one or more first elements 500a-500e arranged in the first layout is a target for the machine learning model, i.e., a target for the content 460 comprising one or more second elements 500a-500e arranged in a second layout (e.g., where the sets of first and second elements are identical). The same techniques discussed above may be applied where the rendered content 460 is generated to include second element(s) not included in the set of first element(s) of the evaluation content 560. For example, the second sequence of tokens 520 may in other examples be “e”, “d”, “b”, “f”, “c”, “a” where an element not included in the elements of the evaluation content 560 has been arranged between “IMAGE #1” 500c and “IMAGE #2” 500a. In another example, “IMAGE #2” 500c may be omitted from the rendered content 460 according to the layout generated. In both of these specific examples, the similarity score 530 remains functional and can reflect whether, for example, an element has been inserted or omitted with respect to the evaluation content 560, in addition to reflecting the similarity of the order of respective elements 500a-500e. Levenshtein Distance as a similarity score 530 is particularly adept for assessing similarity between the first and second sequences 510, 520 because it can measure differences with respect to insertions, deletions, and/or substitutions.

While implementations of the machine learning model 350 (e.g., as described above with reference to FIG. 3 and FIG. 4) did not implement the method for evaluating the performance of the machine learning model 350 specifically for model updates (i.e., training), the same method for evaluation may be applied for that purpose too. In other words, it is envisaged that computing the loss value 390 (i.e., as described with reference to FIG. 3 and in relation to model training) may further be based upon the similarity score 530 and/or evaluation metric 540.

The machine learning model may be evaluated for its performance at arranging elements of the evaluation content (e.g., agnostic to the content of the elements themselves). That is, in some examples such as those depicted in FIG. 5 and FIG. 6, the set of the first elements 500a-500e and the set of the second elements 500a-500e may be identical. However, in other examples, the set of the first and second elements may differ (e.g., where the machine learning model has generated a layout 360 without including elements from the evaluation content 560, or has generated a layout 360 including additional elements not included in the evaluation content 560).

FIG. 6 depicts two sets of elements in content each arranged in a logical order.

As described above, a first and second sequence of tokens 510, 520 are generated based upon a logical order 640, 660 of the first and second elements 500a-500e respectively. The tokens may be any suitable indication, representation, or identifier of a particular element (e.g., a character such as “a” or a numeric value such as “1”). For example, the evaluation content 560 may comprise a five elements 500a-500e. In this example, the logical order 640 of the first to fifth elements 500a-500e in the evaluation content 560 may determine the first sequence of token 510. The logical order 640 of the first to fifth elements 500a-500e may be any suitable logical order 640 (i.e., any order of the first to fifth elements 500a-500e determined based upon predefined logic, such as top-to-bottom and left-to-right ordering or a natural reading/sort order). In implementations, the predefined logic is based upon the relative position of the elements 500a-500e in the layout of the respective content 560, 460. In the foregoing example, the first sequence of tokens 510 may be “a b c d e” if the logical order 640 of the elements 500a-500c is in a natural reading order (top-to-bottom; left-to-right). In other words, the first to fifth elements 500a-500e of the evaluation content 560 may correspond to tokens “a”, “b”, “c”, “d”, and “e” respectively. Every different element or “asset” in the set of the first and second elements 500a-500e, 500a-500e is mapped to a different token to create a sequence of tokens 510, 520 for both the evaluation content 560 and the content 460 (e.g., the first element 500a in the evaluation content 460 may be mapped to “a” and the initial second element in the output content 460 may be mapped to “e”).

To clarify, the meaning of tokens in this particular context may differ from the meaning of tokens described below with reference to the input/output units of a machine learning model. That is, the machine learning model 350 may be a neural network (e.g., autoregressive neural network) that receives inputs and generates outputs in the form of tokens. The tokens in this context may be a numeric value representing, for example, a word, wordpiece, portion of an image, etc. forming part of a predetermined vocabulary of tokens that the machine learning model 350 is configured to receive as input and/or generate as output. In contrast, the tokens of the first and second sequence of tokens 510, 520 may represent, via their tokens, elements 500a-500e in content 560, 460 and their arrangement therein.

As mentioned above, the machine learning model 350 may generate an output layout 360 for the content 460. The content 460 may comprise one or more second elements 500a-500e arranged in a second layout (e.g., indicated by the output layout 360 or data representing the output layout). With reference to the previous example, the output layout 360 may indicate a layout for the content 460 including indications for the layout 360 of the same first to fifth elements 500a-500e of the evaluation content 560. In a similar manner to the evaluation content 560, the logical order 660 of the first to fifth elements 500a-500e in the rendered content 460 may be used to determine the second sequence of tokens 520. In this example, the second sequence of tokens 520 may be “e c b d a”. That is, the logical order 660 of the first to fifth elements 500a-500e in the content 460 (e.g., as indicated by the output layout 360) is fifth, third, second, fourth, first elements in that order. In other words, the first to fifth elements 500a-500e of the evaluation and rendered content 560, 460 may correspond to tokens “a”, “b”, “c”, “d”, and “e” respectively. As will now be readily apparent, the logical order 640 of the first elements 500a-500e in the evaluation content 560 differs from the logical order 660 of the second elements 500a-500e in the content 460, as indicated (or determined) by the output layout, i.e., for the rendered content 460. That is, the first and second sequence of tokens 510, 520 may be used to represent the logical order 640, 660 of the elements 500a-500e of the evaluation content 560 and the content 460 (e.g., each document) and may further be used for evaluating the performance (e.g., accuracy) of the machine learning model used to generate the layout of the rendered content 460, as presently described. That is, the first sequence of tokens 510 (i.e., “a b c d e”) and the second sequence of tokens 520 (i.e., “e c b d a”) may be used to compute the similarity score 530. For example, a Levenshtein Distance score may be computed using these two sequences of tokens 510, 520 (e.g., by comparing the sequences) to determine a similarity score 530 indicating a degree of similarity for the pair 510, 520. The Levenshtein Distance score in this example may be 4. As discussed above, Levenshtein Distance can evaluate insertions, deletions, and substitutions of characters. In this way, the arrangement of the elements 500a-500e in both pieces of content 560, 460, as expressed by their respective sequences of tokens 510, 520, may be effectively evaluated thus resulting in a similarity score 530 indicating a high degree of similarity where the arrangement of elements 500a-500e in the output content 460 substantially matches the arrangement of elements 500a-500e in the evaluation content 560, and a similarity score 530 indicating a low degree of similarity in the opposing case. Accordingly, the evaluation metric implementing the similarity score 530 measures whether the ground truth reading order and narrative flow of the evaluation content 560 is preserved in the generated content 460 (i.e., the layout of which being indicated by the output layout generated using the machine learning model (e.g., 350)). Any suitable similarity score 530 is envisaged for the first and second sequences of tokens 510, 520. The evaluation metric 540 may be any suitable metric incorporating the similarity score 530. The evaluation metric 540 incorporating the similarity score 530 may be the similarity score 530 itself. Particular details on the evaluation metric 540 used in implementations are provided below.

In some implementations, the method may further comprise determining an X-coordinate and a Y-coordinate for each of the one or more first elements 500a-500e in the evaluation content 560. For example, elements 500a-500e of the evaluation content 560 may be determined to have (X, Y) coordinates 600a-600e. In a specific example, element 500a in the evaluation content 560 may be determined to have an X-coordinate of 2 and a Y-coordinate of 1 (i.e., 600a). The method may comprise determining a token corresponding to each of the one or more first elements 500a-500e in the evaluation content 560 and determining the logical order 640 of the one or more first elements 500a-500e based upon the X-coordinates and Y-coordinates 600a-600e for Each of the One or More First Elements 500a-500e. In Such implementations, generating the first sequence of tokens 510 based upon the logical order 640 of the one or more first elements 500a-500e comprises ordering the one or more tokens (e.g., “a”, “b”, “C”, “d”, and “e”) corresponding to each of the one or more first elements 500a-500e in the evaluation content 560 according to the logical order 640 of the one or more first elements 500a-500e. In such implementations, the method may further comprise determining an X-coordinate and a Y-coordinate for each of the one or more second elements 500a-500e in the content 460. For example, elements 500a-500e of the rendered content 460 may be determined to have (X, Y) coordinates 610a-610e. In a specific example, element 500a in the rendered content 460 may be determined to have an X-coordinate of 0 and a Y-coordinate of 4 (i.e., 610a). The method may comprise determining a token corresponding to each of the one or more second elements 500a-500e in the content 460 and determining the logical order 660 of the one or more second elements 500a-500e based upon the X-coordinates and Y-coordinates 610a-610e for each of the one or more second elements 500a-500e. In such implementations, generating the second sequence of tokens 520 based upon the logical order 660 of the one or more second elements 500a-500e comprises ordering the one or more tokens (e.g., “a”, “b”, “c”, “d”, and “e”) corresponding to each of the one or more second elements 500a-500e in the content 460 according to the logical order 660 of the one or more second elements 500a-500e.

That is, for every element 500a-500e or “asset” in both pieces of content 560, 460 (e.g., in two documents), an X and Y coordinate 600a-600e, 610a-610e may be determined, e.g., to indicate its relative position in the layout of the respective content. In implementations, the X and Y coordinates 600a-600e, 610a-610e for a respective element were identified based upon a centroid of a bounding box of the respective element. However, the X and Y coordinates 600a-600e, 610a-610e for a given element may be determined in any suitable way (e.g., top-right, top-left, bottom-right, or bottom-left corner of a respective element; e.g., bottom-left corner in the case of element 500c). Accordingly, the elements 500a-500e in some given content 560, 460 may be sorted based upon their coordinates (location) in the layout of that content 560, 460. For example, the elements in the evaluation content 560, as previously described, may correspond to (X, Y) coordinates (2, 1), (1, 2), (3, 2), (0, 3), and (0, 4) respectively. In this example, the first sequence of tokens 510 (i.e., the sequence of tokens for the evaluation content 560) may be generated according to these X and Y coordinates 600a-600e, i.e., the logical order 640 of the first elements 500a-500e may be determined accordingly. In another example, the elements in the output content 460, as previously described, may correspond to (X, Y) coordinates (3, 1), (1, 2), (3, 2), (0, 3), and (0, 4) respectively. The X and Y coordinates 600a-600e for elements 500a, 500b, 500c, and 500e in the evaluation content 560 differs from the X and Y coordinates 610a-610e for the same elements in the output content 460. By determining the logical order 640, 660 in this way, the relative position of a given element 500a-500e may be taken into account when forming a sequence of tokens 510, 520 representing the logical order of elements 500a-500e in a given piece of content 560, 460. The logical order of the first and second elements 500a-500e may be determined by sorting the respective elements 500a-500e according to their corresponding X and Y coordinates 600a-600e, 610a-610e. For example, the sorting may occur by initially sorting by Y-coordinates and subsequently by sorting by X-coordinates (and vice versa).

In some implementations, the logical order 640, 660 of the one or more first and second elements 500a-500e is determined by sorting the respective first or second elements 500a-500e according to a sorting hierarchy (not depicted). A first order of the sorting hierarchy may be based upon the Y-coordinates of the one or more first or second elements 500a-500e and a second order of the sorting hierarchy may be based upon the X-coordinates of the one or more first or second elements. The sorting hierarchy may be a natural sort order.

As referred to herein, a “sorting hierarchy” is logical structure for sorting elements 500a-500e based on levels of criteria or significance in the sorting operation. In the sorting hierarchy, sorting is broken down into levels, or “orders,” where the elements are first sorted by the most significant criterion (e.g., Y-coordinate), then by the next criterion (e.g., X-coordinate) within groups formed by the previous sort. That is, in the previous example, the second sequence of tokens 520 may be sorted firstly according to values 4, 2, 3, 1, and 2 (i.e., the Y coordinates for the elements 500a-500e of the output content 460) and secondly according to values 0, 3, 0, 3, and 1 (i.e., the X coordinates for the elements 500a-500e of the output content 460). The logical order 640, 660 of the first and second elements 500a-500e respectively may be determined according to a top-to-bottom (first order) and left-to-right (second order) scheme (e.g., a natural sort order). In this way, the order of elements 500a-500e, as represented by their respective first and second sequences of tokens 510, 520, aligns with one common natural reading order. Therefore, once computed based upon the first and second sequences of tokens 510, 520, the similarity score 530 reflects this naturally ordered scheme and therefore indicates whether the elements 500a-500e in the output content 460 are arranged in a semantically meaningful and coherent manner.

In some implementations, the evaluation metric is generated according to:

$$1 - \frac{lev ( \hat{y} , y )}{max ( \vert y \vert , \vert \hat{y} \vert )}$$

In such implementations, y represents the ground truth data (e.g., the evaluation content 560), ŷ represents the output layout 460, lev(ŷ, y) represents the similarity score 530, and max(|y|,|ŷ|) represents a largest number in a set of numbers consisting of a first number of tokens in the first sequence of token and a second number of tokens in the second sequence of token. For example, the largest number in the set of numbers may be 5 where the first sequence of tokens 510 comprises 5 unique tokens and the second sequence of tokens 520 comprises 3 unique tokens. In this example, 5 is the largest number in the set of {5, 3}.

That is, the particular evaluation metric 540 may take into account both the similarity score 530 and the greater of the total number of elements (as reflected by the number of tokens in a given sequence) in both the evaluation content 560 and the output content 460. As an example, if the first sequence of tokens 510 is “a b c d e” and the second sequence of tokens 520 is “a b d c f e”, max(|y|,|ŷ|) may be equal to 6 and the similarity score 530 may be equal to 2 (e.g., if using Levenshtein Distance score as the similarity score 530). Accordingly, the evaluation metric 540 in this specific example may be equal to 1-(2/6), or 0.666. A higher evaluation metric 540 may indicate that performance of the machine learning model (that generated the output layout of the content 460) is greater than another machine learning model that achieves a lower evaluation metric 540 performing the same task, e.g., lower than 0.666. The evaluation metric 540 may be aggregated across multiple comparisons of rendered content 460 with multiple different evaluation content 560). By calculating the evaluation metric 540 in this way, the performance of machine learning models (i.e., the machine learning model 350 described herein, in addition to other user-constrained machine learning models) may be accurately evaluated by not only focusing on geometric structure of the generated content (e.g., geometric structure of elements 500a-500e) but also incorporating factors such as element arrangement and the number of elements into the evaluation.

Referring now to aspects of FIG. 1 to FIG. 6 collectively (i.e., for training dataset generation, inference, and/or training), in some implementations, each of the elements 100a-100e, 400, 500a-500e is text, an image, a heading, a table, a graph, a chart, a list of items, a form, a video item, or an audio item.

That is, the elements as previously described may be any suitable element of some content (e.g., any suitable element of a document), but in particular one of the foregoing types of elements.

In some implementations, the output layout 360 is serialized data.

In some examples, the output layout 360 is Protobuf data or a “Protobuf buffer”. That is, the output layout 360 (and indeed its corresponding ground truth layout data 370 in the context of training) may be serialized data such as Protobuf data, e.g., in the context of output from the machine learning model 350. In other words, the serialized data may be a serialized text representation of the layout of the content 460, e.g., acting as functional data for arranging elements 500a-500e. The serialized data may further include the elements of the content 460, or any other attribute or property of the content 460 for further processing. In some examples, the serialized data is configured to be used (e.g., by a computing system 110) to generate an image (e.g., SVG image) representing the content 460—thus “rendering” the content 460. The rendering may occur in any other suitable way (e.g., by rendering a PDF based upon the layout prediction 360). By representing the output data 360 as serialized data (e.g., serialized text data), this allows for human interpretability, which facilitates visual inspection of the generated layouts 360 and addresses challenges related to direct image generation (i.e., the machine learning model 350 need not render the content itself, which may otherwise lead to poor accuracy and high computational cost). Moreover, serialized data provides a compact and computationally efficient representation of content layouts, which may otherwise be inefficient to store and read. This improved computational efficiency is a specific, real-world advantage and offers a number of practical applications for the machine learning model 350.

More broadly, by outputting a compact, output layout (e.g., as opposed to inferring the content per se), the machine learning model 350 uses less memory, processing power, and network bandwidth. This makes the machine learning model 350 suitable for deployment in resource-constrained environments, such as on-device applications (e.g., in mobile applications) or in high-throughput, server-side systems where processing efficiency is a critical, concrete requirement.

In some implementations, the machine learning model 350 is a multimodal machine learning model configured to receive text data and image data as input to generate the output layout 360.

That is, the machine learning model 350 (e.g., as previously described with reference to preceding aspects) may be a vision-language model (VLM). In some examples, the machine learning model 350 is a Transformer-based machine learning model comprising one or more attention layers. In some examples, the machine learning model 350 is autoregressive, i.e., the machine learning model 350 is configured to generate a predicted next output token for a current output sequence of tokens. In this example, the machine learning model 350 may generate output over a plurality of iterations, the machine learning model 350 being configured to generate a next output token at each iteration which is appended to the current output sequence of tokens for further processing as an input at subsequent iterations. In implementations, the machine learning model 350 used as a fine-tuned version of PailGemma 3B. In some examples, the machine learning model 350 has been pre-trained on one or more code (e.g., programming code) generation tasks. By pre-training the machine learning model 350 in this way, the machine learning model 350, in experiments, was shown to effectively generate accurate and syntactically correct layouts without incurring syntax errors. This improvement in accuracy ensures that the content 460 can be rendered properly.

Referring now to FIG. 4, i some implementations the machine learning model 350 comprises a vision encoder 420 configured to receive image data as input to generate a first latent representation 422 of the image data, a text encoder 430 configured to receive text data as input to generate a second latent representation 432 of the text data, a concatenation layer 440 configured to concatenate the first latent representation 422 with the second latent representation 432 to generate a third latent representation 442, and a transformer decoder 450 configured to receive the third latent representation 442 as input to generate the output layout 360 for the content 460. This model architecture may apply to the machine learning model 350 used during training and/or inference.

In some implementations, the vision encoder 420 is further configured to receive each of the one or more elements 400 represented by the image data as input and in response generate a corresponding patch embedding (not depicted). In such implementations, the vision encoder 420 is further configured to receive the user-generated representation 410 (which in general may be an image) and in response generate a corresponding user-generated representation embedding (not depicted). In such implementations, the first latent representation 422 of the image data is a concatenation of each of the patch embeddings (representing the image elements in the input) and the user-generated representation embedding (representing the user-generated representation of the layout 410).

That is, the vision encoder 420 may receive a different image as input for each of the one or more elements 400 (i.e., rather than one image as a whole). In other words, the visual backbone of the model (i.e., the vision encoder 420) is applied independently on each input image (e.g., one or more of the elements 400) and the resulting embeddings are concatenated for further processing (i.e., by the transformer decoder). In this way, the visual encoder 420 serves as a feature extractor for both the user-generated representation 410 (e.g., a handwritten sketch) and the separate elements 400 or “assets”. However, by using the vision encoder 420 to process the user-generated representation 410 (representing potentially multiple elements) as an individual input, in contrast to processing the element image data independently, absolute and relative positions of the respective element representations (i.e., as represented in the user-generated representation) in the intended arrangement for the layout 360 are effectively extracted. Accordingly, the machine learning model 350 may be trained to infer the correct semantic order and position of respective elements 400 in the output content 460. In other words, the final and desired structure for the content 460 is provided to the machine learning model 350 via the user-generated representation 410, thus enabling the machine learning model 350 to understand where to place elements 400 in the resulting content 460 according to the desired content and structure, such as where to place elements 400 in a resulting document.

In some implementations, the output layout 360 is data indicating one or more elements 400 for the content 460 (e.g., serialized data indicating a particular element identifier that signals the corresponding element should be included in the content 460), a layout for the one or more elements 400 in the content (e.g., serialized data indicating positions for particular elements on a 2D plane), a name identifier (e.g., “elementA”) for each of the one or more elements 400, a bounding box for each of the one or more elements indicating a position for the respective element in the layout (e.g., a set of four (X,Y) coordinates defining a grid around a location in a 2D plane for a given element), and/or one or more properties corresponding to each respective element (e.g., aspect ratio, width, height, color intensity, effects to be applied during rendering, etc.).

As an example, the output layout 360 may include data indicating: “elements”: [{“name”: “image1”, “bbox”: {“xmin”: 18, “ymin”: 891, “width”: 86, “height”: 91}}, . . . ]”, where the elements 400 for the content 460 are indicated by the key “elements” (i.e., each dictionary of the specified array indicates data representative of given element for inclusion in the rendered content 460), the name identifier is indicated by the key “name”, the bounding box for each of the elements 400 is indicated by the key “bbox”, the properties are indicated by, e.g., at least keys “width” and “height”, and the layout for the one or more elements in the content 460 is indicated by, for example, the one or more “bbox” properties for each of the elements and the spatial relationship that is defined between bounding boxes for different elements. Of course, any number of suitable properties are envisaged (e.g., font size and font style for text elements). The output layout 360 may, in some examples, include data indicating content of the respective elements (e.g., image data where the element is an image).

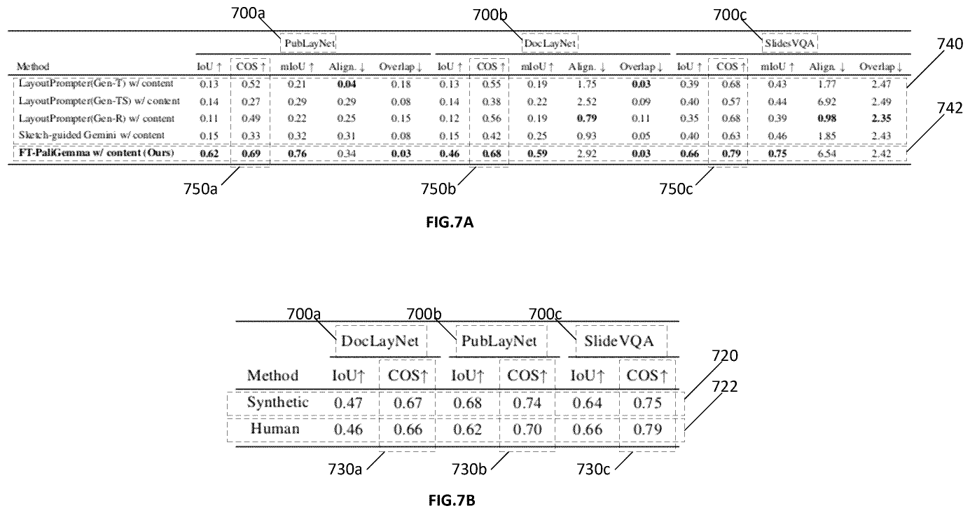

FIG. 7A depicts a first table of experimental results. FIG. 7B depicts a second table of experimental results.

In the experiments, the techniques described herein were compared to prior techniques using a number of different evaluation metrics, including the evaluation metric 540 described herein, across three different evaluation datasets 700a-700c. The evaluation metric 540 described with reference to FIG. 5 is referred to in the first table as a Content Ordering Score (COS) and represents results 750a-750c. The results in the first table highlighted in bold represent the best results for each metric. For Intersection over Union (IoU), COS, and Maximum IoU (mIoU), a higher evaluation metric indicates a better performing method (technique). IoU measures whether a given element correctly matches the position of the same element in the rendered content 460. mIoU measures whether the position of an element in the rendered content 460 matches the position of any element in the evaluation content 560 and is based upon the most overlapping pair of elements from the evaluation and rendered content 560, 460 in this regard. For Alignment (“Align”) and Overlap, a lower evaluation metric indicates a better performing method. Alignment measures graphical alignment of elements in the layout of rendered content 460. Overlap measures the percentage of overlap between elements in the layout of rendered content 460.

The present results 742 (i.e., for “FT-PaliGemma w/content”) show that the techniques described herein outperform the prior techniques (i.e., “LayoutPrompter” and “Sketch-guided Gemini”) in a number of regards, including by COS score. For context, the present results 742 were gathered using a fine-tuned (trained) version of PailGemma with elements (content) provided as an input in addition to being sketch-guided (i.e., including the use of a user-generated representation 410 as an input to the machine learning model 350). The training of PailGemma included training the model on a training dataset 140 which was generated to include synthetic user-generated representations, as previously described with reference to FIG. 1 to FIG. 3. The present results 742 thus validate the generation and use of synthetic user-generated representations of layout as a viable means for improving real-world practical application of machine learning models to generate accurate layouts of content. In detail, the machine learning model 350 trained on the training dataset 140 exhibited optimal performance (accuracy) in the majority of permutations of different metrics and datasets 700a, 700b, 700c.

The second table of results depicted in FIG. 7B reinforces the validity of using the training dataset 140 of synthetic representations rather than, for example, only using user-generated representations per se. This is because there is only a minimal distributional shift between the results for the model trained using user-generated representations per se (see results 720) and the results for the model trained using synthetic user-generated representations (see results 722). The benefits, as discussed above, of automatically generating a large number of diverse training example representations far outweighs the marginal benefit of using the same amount of “real” user-generated representations. That is, much larger and more diverse training sets can be created on demand without requiring human-input, thus expediting training and practical application of the machine learning model for its intended purpose.

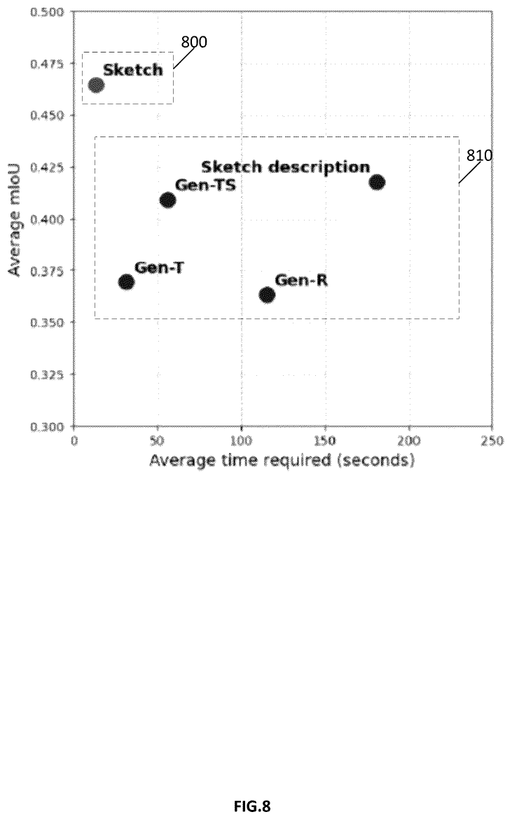

FIG. 8 depicts a first chart of experimental results.

The first chart depicts results 800 for a method using user-generated representations of layout as an input to the machine learning model 350 (analogous to the method described with reference to FIG. 4) compared results 810 for four other methods of defining user-constraints (conditions) in the input of the machine learning model to generate layouts: “Gen-T”, “Gen-TS”, “Gen-R” and “Sketch description”. “Gen-T” only defined the type of the elements (e.g., text or image) as part of the input to the machine learning model. “Gen-TS” only defined element type and size (e.g., text or image and their respective width/height dimensions) of the element as part of the input to the machine learning model. “Gen-R” only defined spatial relationship between elements (e.g., elementA is adjacent to elementB) as part of the input to the machine learning model. “Sketch description” only defined a written word description of the intended sketch as part of the input to the machine learning model. The results 800, 810 depicted in the first chart were generated during experiments using the SlideVQA dataset 700c for evaluation. The results 800 using a user-generated representation of layout as an input exhibited a better average mIoU metric and lower average time required to generate an output layout than all other methods. This validates the real-world improvement that training machine learning models on user-generated representations (and thus synthetic representations, which are a valid proxy thereto) offers, both in terms of accuracy and time complexity.

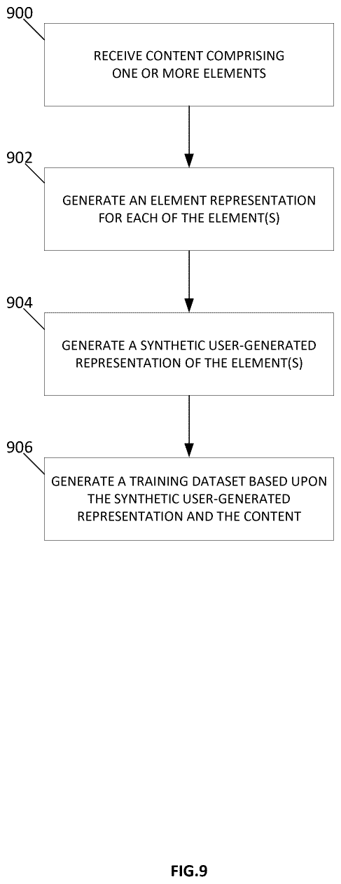

FIG. 9 depicts a flow diagram of a method for generating a training dataset in accordance with the techniques described herein.

At step 900, the method comprises receiving content comprising one or more elements.

At step 902, the method comprises generating an element representation for each of the one or more elements by processing the content and one or more user-generated primitive element representations.

At step 904, the method comprises generating a synthetic user-generated representation of the one or more elements based upon the one or more user-generated primitive element representations and the layout of the one or more elements in the content.

At step 906, the method comprises generating the training dataset based upon the synthetic user-generated representation and the content.

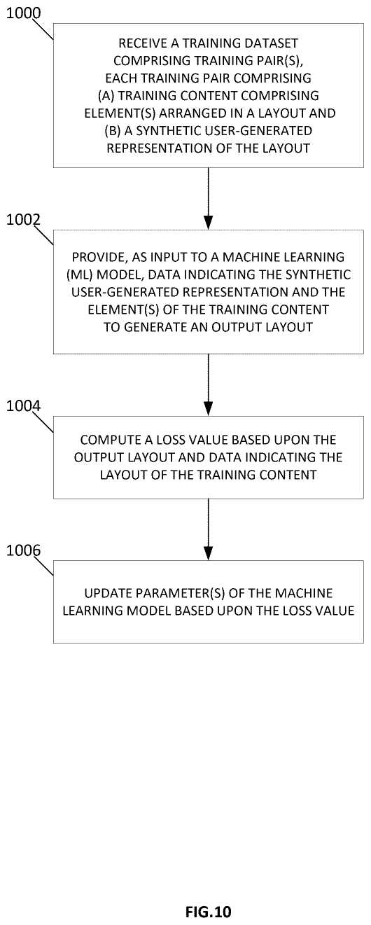

FIG. 10 depicts a flow diagram of a method for training a machine learning model to generate an output layout for content in accordance with the techniques described herein.

At step 1000, the method comprises receiving a training dataset comprising one or more training pairs. Each training pair comprises training content comprising one or more elements arranged in a layout and a synthetic user-generated representation of the layout of the training content.

At step 1002, the method comprises providing data indicating the synthetic user-generated representation and data indicating the one or more elements of the training content as an input to a machine learning model to generate the output layout for the content.

At step 1004, the method comprises computing a loss value based upon the output layout for the content and data indicating the layout of the training content.

At step 1006, the method comprises updating one or more parameters of the machine learning model based upon the loss value.

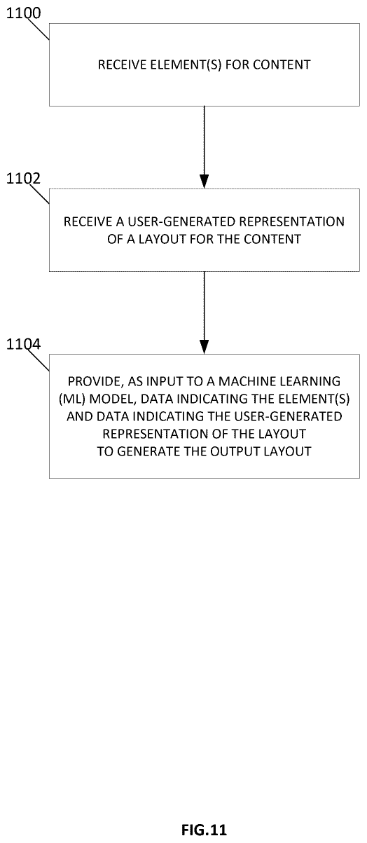

FIG. 11 depicts a flow diagram of a method for generating an output layout for content in accordance with the techniques described herein.

At step 1100, the method comprises receiving one or more elements for the content.

At step 1102, the method comprises receiving a user-generated representation of a layout for the content.

At step 1104, the method comprises providing, as input to a machine learning model, data indicating the one or more elements for the content and data indicating the user-generated representation of the layout to generate the output layout for the content.

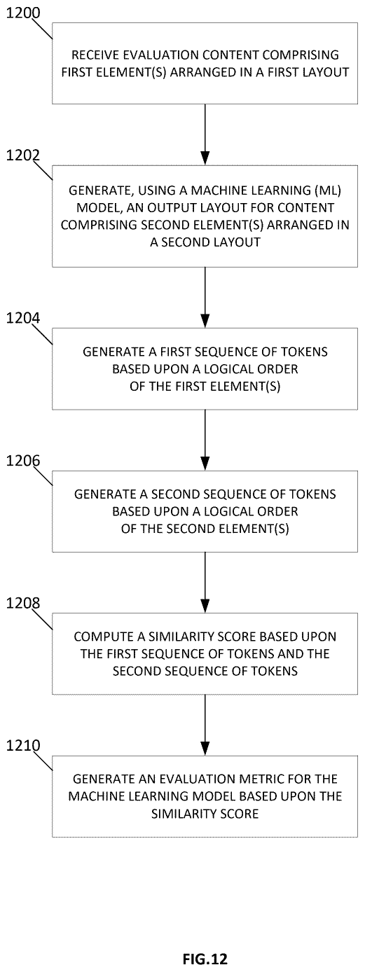

FIG. 12 depicts a flow diagram of a method for evaluating performance of a machine learning model in accordance with the techniques described herein.

At step 1200, the method comprises receiving evaluation content, the evaluation content comprising one or more first elements arranged in a first layout.

At step 1202, the method comprises generating, using the machine learning model, an output layout for content comprising one or more second elements arranged in a second layout.

At step 1204, the method comprises generating a first sequence of tokens based upon a logical order of the one or more first elements in the evaluation content, wherein the first sequence of tokens comprises a token for each of the one or more first elements.

At step 1206, the method comprises generating a second sequence of tokens based upon a logical order of the one or more second elements in the content, wherein the second sequence of tokens comprises a token for each of the one or more second elements.

At step 1208, the method comprises computing a similarity score based upon the first sequence of tokens and the second sequence of tokens.

At step 1210, the method comprises generating an evaluation metric for the machine learning model based upon the similarity score, the evaluation metric indicating the performance of the machine learning model.

Further aspects are defined in the following clauses:
1. A computer-implemented method for generating a training dataset, the method comprising: receiving content comprising one or more elements; generating an element representation for each of the one or more elements by processing the content and one or more user-generated primitive element representations; generating a synthetic user-generated representation of the one or more elements based upon the one or more user-generated primitive element representations and the layout of the one or more elements in the content; and generating the training dataset based upon the synthetic user-generated representation and the content.
2. The method of any preceding clause, further comprising: receiving the one or more user-generated primitive element representations, each user-generated primitive element representation indicating at least a portion of an exemplary element, each user-generated primitive element representation generated by a human annotator.
3. The method of clause 2, further comprising generating, by the human annotator, the one or more user-generated primitive element representations.
4. The method of clause 2 or 3, wherein processing the content and the one or more user-generated primitive element representations comprises: determining, for each of the one or more elements, one or more query properties; determining, for each of the one or more user-generated primitive element representations, one or more reference properties; and identifying, for each of the one or more elements, a first set of the one or more user-generated primitive element representations based upon the respective one or more query properties and the one or more reference properties for each of the one or more user-generated primitive element representations; and wherein generating a respective element representation for each of the one or more elements is based upon the respective first set of the one or more user-generated primitive element representations.
5. The method of clause 4, wherein the query properties and the reference properties are each a type of property including: a width, a height, a font size, font style, or an aspect ratio of the respective element or user-generated primitive element representation.
6. The method of clauses 4 or 5, wherein generating the respective element representation for each of the one or more elements based upon the respective first set comprises selecting one of the user-generated primitive element representations from the respective first set at random.
7. The method of clauses 4 to 6, wherein the one or more query properties for the respective element is represented by a first vector comprising one or more first normalized values, each first normalized value corresponding to a different one of the respective query properties, and wherein the one or more reference properties for the respective user-generated primitive element representation is represented by a second vector comprising one or more second normalized values, each second normalized value corresponding to a different one of the respective reference properties.
8. The method of clause 7, wherein identifying, for each respective element of the one or more elements, the first set of the one or more user-generated primitive element representations based upon the respective one or more query properties and the one or more reference properties for each of the one or more user-generated primitive element representations comprises: determining the first vector for the respective element; determining, for each of the user-generated primitive element representations, the second vector for the respective user-generated primitive element representation; computing, for each of the user-generated primitive element representations, a corresponding similarity score indicating a degree of similarity based upon the first vector and the respective second vector; and identifying the first set based upon the one or more similarity scores.
9. The method of clause 8, wherein the similarity score is a Euclidean Distance score.
10. The method of clause 8 or 9, wherein identifying the first set based upon the one or more similarity scores comprises selecting a predetermined number of the user-generated primitive element representations for inclusion in the first set.
11. The method of clause 10, wherein each of the selected user-generated primitive representations correspond to a similarity score indicating a higher degree of similarity than any similarity score corresponding to a user-generated primitive element representation not selected for inclusion in the first set.
12. A computer-implemented method for training a machine learning model to generate an output layout for content, the method comprising: receiving a training dataset comprising one or more training pairs, each training pair comprising: training content comprising one or more elements arranged in a layout; and a synthetic user-generated representation of the layout of the training content; providing data indicating the synthetic user-generated representation and data indicating the one or more elements of the training content as an input to a machine learning model to generate the output layout for the content; computing a loss value based upon the output layout for the content and data indicating the layout of the training content; and updating one or more parameters of the machine learning model based upon the loss value.
13. The method of clause 12, wherein providing the data indicating the one or more elements of the training content as the input to the machine learning model comprises: determining an element input data item for each of the one or more elements of the training content based upon the data indicating the one or more elements; and generating the input to the machine learning model by randomly ordering the one or more element input data items in the input.
14. The method of clause 12 or 13, wherein receiving a training dataset comprises receiving a training dataset generated according to the method of clauses 1 to 11.
15. A computer-implemented method for generating an output layout for content, the method comprising: receiving one or more elements for the content; receiving a user-generated representation of a layout for the content; and providing, as input to a machine learning model, data indicating the one or more elements for the content and data indicating the user-generated representation of the layout to generate the output layout for the content.
16. The method of clause 15, further comprising: generating, based upon the output layout and the one or more elements for the content, the content.
17. The method of clauses 15 or 16, further comprising: receiving an instruction indicating one or more properties for the layout of the content; and wherein generating the output layout using the machine learning model is further based upon the instruction indicating the one or more properties.
18. The method of clauses 15, 16, or 17, wherein the machine learning model has been trained according to the method of any one of clauses 12 to 14.
19. The method of any preceding clause, wherein the user-generated representations are a handwritten sketch or wireframe schematic.
20. A computer-implemented method for evaluating performance of a machine learning model, the method comprising: receiving evaluation content, the evaluation content comprising one or more first elements arranged in a first layout; generating, using the machine learning model, an output layout for content comprising one or more second elements arranged in a second layout; generating a first sequence of tokens based upon a logical order of the one or more first elements in the evaluation content, wherein the first sequence of tokens comprises a token for each of the one or more first elements; generating a second sequence of tokens based upon a logical order of the one or more second elements in the content, wherein the second sequence of tokens comprises a token for each of the one or more second elements; computing a similarity score based upon the first sequence of tokens and the second sequence of tokens; and generating an evaluation metric for the machine learning model based upon the similarity score, the evaluation metric indicating the performance of the machine learning model.
21. The method of clause 20, wherein the similarity score is a Levenshtein Distance score.
22. The method of clause 20 or 21, further comprising: determining an X-coordinate and a Y-coordinate for each of the one or more first elements in the evaluation content; determining a token corresponding to each of the one or more first elements in the evaluation content; determining the logical order of the one or more first elements based upon the X-coordinates and Y-coordinates for each of the one or more first elements; wherein generating the first sequence of token based upon the logical order of the one or more first elements comprises ordering the one or more tokens corresponding to each of the one or more first elements in the evaluation content according to the logical order of the one or more first elements; determining an X-coordinate and a Y-coordinate for each of the one or more second elements in the content; determining a token corresponding to each of the one or more second elements in the content; determining the logical order of the one or more second elements based upon the X-coordinates and Y-coordinates for each of the one or more second elements; and wherein generating the second sequence of token based upon the logical order of the one or more second elements comprises ordering the one or more tokens corresponding to each of the one or more second elements in the content according to the logical order of the one or more second elements.
23. The method of clause 22, wherein the logical order of the one or more first and second elements is determined by sorting the respective first or second elements according to a sorting hierarchy, a first order of the sorting hierarchy based upon the Y-coordinates of the one or more first or second elements and a second order of the sorting hierarchy based upon the X-coordinates of the one or more first or second elements.
24. The method of any of clauses 20 to 23, wherein the evaluation metric is generated according to:

$$1 - \frac{lev ( \hat{y} , y )}{max ( \vert y \vert , \vert \hat{y} \vert )} ;$$

wherein y represents the ground truth data, ŷ represents the output layout, lev(ŷ, y) represents the similarity score, and max(|y|,|ŷ|) represents a largest number in a set of numbers consisting of: a first number of tokens in the first sequence of token; and a second number of tokens in the second sequence of token.
25. The method of any preceding clause, wherein each of the elements is text, an image, a heading, a table, a graph, a chart, a list of items, a form, a video item, or an audio item.
26. The method of clauses 12 to 25, wherein the output layout is serialized data.
27. The method of clauses 12 to 26, wherein the machine learning model is a multimodal machine learning model configured to receive text data and image data as input to generate the output layout.
28. The method of clauses 12 to 27, wherein the machine learning model comprises: a vision encoder configured to receive image data as input to generate a first latent representation of the image data; a text encoder configured to receive text data as input to generate a second latent representation of the text data; a concatenation layer configured to concatenate the first latent representation with the second latent representation to generate a third latent representation; and a transformer decoder configured to receive the third latent representation as input to generate the output layout for the content.
29. The method of clause 28, wherein: the vision encoder is further configured to receive each of the one or more elements represented by the image data as input and in response generate a corresponding patch embedding; the vision encoder is further configured to receive the user-generated representation and in response generate a corresponding user-generated representation embedding; and the first latent representation of the image data is a concatenation of each of the patch embeddings and the user-generated representation embedding.
30. The method of clauses 12 to 29, wherein the output layout is data indicating: one or more elements for the content, a layout for the one or more elements in the content, a name identifier for each of the one or more elements, a bounding box for each of the one or more elements indicating a position for the respective element in the layout, and/or one or more properties corresponding to each respective element.
31. A computing system comprising: one or more processors; and one or more non-transitory computer-readable media storing computer-readable instructions configured to cause one or more processors to perform a method according to any one of the preceding clauses.
32. One or more non-transitory computer-readable media storing computer-readable instructions configured to cause one or more computing devices to perform a method according to any one of the preceding clauses.

The machine learning models (e.g., the machine learning models described with reference to training a model to generate an output layout for content, generating an output layout for content, and evaluating the performance of a machine learning model) as described herein may be neural networks. For example, the machine learning models may comprise a neural network having one or more (self-)attention layers, such as a Transformer neural network. The neural networks may be any of a variety of Transformer-based neural network architectures for example. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al., Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block. It will be readily appreciated that such neural networks having a Transformer-based architecture may be used to generate the embeddings as described herein, for example, by sampling the input hidden states for a given block.

The inputs and outputs to the machine learning models described herein may comprise tokens. For example, the user-generated representations and the elements of content may be represented as one or more input tokens (i.e., inputs to the machine learning model) and the output layout may be represented as one or more output tokens (i.e., outputs generated by the machine learning model). In specific implementations, the input tokens represented text (e.g., text for a document) and images (e.g., the user-generated representations) and the output tokens represented text generated by the machine learning model (i.e., textual serialized data or a “Protobuf buffer”) indicating the output layout. In some implementations, the tokens can represent text, e.g., words, wordpieces or characters, in a natural or computer language. For example, text may be received, e.g., as a series of encoded characters, e.g., UTF-8 encoded characters; such “characters” can include Chinese and other similar characters, as well as logograms, syllabograms and the like. A text encoder, i.e., a tokenizer, can process a sequence of text to represent the text as a series of text tokens from a vocabulary of text tokens, e.g., that each represent words, wordpieces or characters in a natural or computer language. The computer language may be any formal language used to communicate with a computer, e.g., a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data that represent speech corresponding to the text.

Also or instead the tokens may represent an image. For example, a set (sequence) of input or output tokens can represent an image. Each image token may comprise a block encoding of values of the pixels in a different region of an image that maps a set of values of the pixels to a respective image token. The block encoder may comprise a neural network, e.g., having one or more (self-)attention layers, such as a Transformer neural network as previously described.

Also or instead the tokens may represent an audio waveform. For example, a set (sequence) of input or output tokens can represent audio data representing a waveform e.g., instantaneous audio amplitude values or time-frequency audio data. Each image token may comprise a block encoding of the audio waveform in a different time segment of the audio that maps a set of values representing the audio waveform to a respective image token.

In some implementations, the machine learning models described herein are pre-trained, e.g., trained on a particular modeling task prior to further training or inference. For example, the machine learning models described herein may be language models, vision models, multi-modal models, or any other suitable type of machine learning model that has been trained prior to inference and is suitable for processing the database data items described herein. In specific implementations, as described, the machine learning models described herein were pre-trained on a code generation task.

To illustrate, a system may pre-train a language model on a language modeling task, e.g., a task that requires predicting, given a current sequence of text tokens, the next token that follows the current sequence in the training data. As a particular example, the language model can be pre-trained on a maximum-likelihood objective on a large dataset of text, e.g., text that is publicly available from the Internet or another text corpus. It will be readily appreciated that the machine learning models described herein may further be fine-tuned to a particular task (e.g., a particular type of content layout generation).

A description of self-attention, as may be employed by some of the machine learning models described herein, now follows.

A self-attention block, as referred to above, is a neural network layer that includes an attention mechanism that operates over the self-attention block input (or an input derived from the layer input) to generate the self-attention block output. A self-attention mechanism may be causally masked so that any given position in an input sequence does not attend over (e.g., use data from) any positions after the given position in the input sequence. There are many different possible attention mechanisms. Some examples of self-attention layers including attention mechanisms, are described in Vaswani, et al., “Attention is all you need”, 31st Conference on Neural Information Processing Systems (NIPS 2017), Long Beach, CA, USA; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners. arXiv preprint arXiv:2005.14165, 2020.

Generally, an attention mechanism maps a query and a set of key-value pairs to an output, where the query, keys, and values are all vectors. The output is computed as a weighted sum of the values, where the weight assigned to each value is computed by a compatibility function, e.g., a dot product or scaled dot product, of the query with the corresponding key.

Generally, a self-attention mechanism is configured to relate different positions in the same sequence to determine a transformed version of the sequence as an output. For example, the attention layer input may comprise a vector for each element of the input sequence. These vectors provide an input to the self-attention mechanism and are used by the self-attention mechanism to determine a new representation of the same sequence for the attention layer output, which similarly comprises a vector for each element of the input sequence. An output of the self-attention mechanism may be used as the attention layer output, or it may be processed by one or more of feed-forward layers, skip connections, or normalization operations to provide the attention layer output.

In some implementations the attention mechanism is configured to apply each of a query transformation, e.g., defined by a matrix W^{Q}, a key transformation, e.g., defined by a matrix W^{K}, and a value transformation, e.g., defined by a matrix W^{V}, to the attention layer input which is the input data X to the attention layer, to derive a query matrix Q=XW^{Q} that includes a respective query for each vector in the input sequence, key matrix K=XW^{K} that includes a respective key for each vector in the input sequence, and value matrix V=XW^{V} that includes a respective value for each vector in the input sequence, which are used determine an attended sequence for the output. For example, the attention mechanism may be a dot product attention mechanism applied by applying each query vector to each key vector to determine respective weights for each value vector, then combining the value vectors using the respective weights to determine the self-attention layer output for each element of the input sequence. The self-attention layer output may be scaled by a scaling factor, e.g., by the square root of the dimensions of the queries and keys, to implement scaled dot product attention. Thus, for example, an output of the attention mechanism may be determined as

$$softmax ( \frac{Q {K}^{T}}{\sqrt{d}} ) V$$

where d is a dimension of the key (and value) vector. In another implementation the attention mechanism comprises an “additive attention” mechanism that computes the compatibility function using a feed-forward network with a hidden layer. The output of the attention mechanism may be further processed by one or more fully-connected, feed forward neural network layers.

The attention mechanism may implement multi-head attention, that is, it may apply multiple different attention mechanisms in parallel. The outputs of these may then be combined, e.g., concatenated, with a learned linear transformation applied to reduce to the original dimensionality if necessary.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Data processing apparatus for implementing machine learning models can also include, for example, special-purpose hardware accelerator units for processing common and compute-intensive parts of machine learning training or production, e.g., inference, workloads.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for generating a training dataset, the method comprising:
receiving content comprising one or more elements;
generating an element representation for each of the one or more elements by processing the content and one or more user-generated primitive element representations;
generating a synthetic user-generated representation of the one or more elements based upon the one or more user-generated primitive element representations and the layout of the one or more elements in the content; and
generating the training dataset based upon the synthetic user-generated representation and the content.

2. The method of claim 1, further comprising:
receiving the one or more user-generated primitive element representations, each user-generated primitive element representation indicating at least a portion of an exemplary element, each user-generated primitive element representation generated by a human annotator.

3. The method of claim 2, further comprising generating, by the human annotator, the one or more user-generated primitive element representations.

4. The method of claim 2, wherein processing the content and the one or more user-generated primitive element representations comprises:
determining, for each of the one or more elements, one or more query properties;
determining, for each of the one or more user-generated primitive element representations, one or more reference properties; and
identifying, for each of the one or more elements, a first set of the one or more user-generated primitive element representations based upon the respective one or more query properties and the one or more reference properties for each of the one or more user-generated primitive element representations; and
wherein generating a respective element representation for each of the one or more elements is based upon the respective first set of the one or more user-generated primitive element representations.

5. The method of claim 4, wherein the query properties and the reference properties are each a type of property including: a width, a height, a font size, font style, or an aspect ratio of the respective element or user-generated primitive element representation.

6. The method of claim 4, wherein generating the respective element representation for each of the one or more elements based upon the respective first set comprises selecting one of the user-generated primitive element representations from the respective first set at random.

7. The method of claim 4, wherein the one or more query properties for the respective element is represented by a first vector comprising one or more first normalized values, each first normalized value corresponding to a different one of the respective query properties, and
wherein the one or more reference properties for the respective user-generated primitive element representation is represented by a second vector comprising one or more second normalized values, each second normalized value corresponding to a different one of the respective reference properties.

8. The method of claim 7, wherein identifying, for each respective element of the one or more elements, the first set of the one or more user-generated primitive element representations based upon the respective one or more query properties and the one or more reference properties for each of the one or more user-generated primitive element representations comprises:
determining the first vector for the respective element;
determining, for each of the user-generated primitive element representations, the second vector for the respective user-generated primitive element representation;
computing, for each of the user-generated primitive element representations, a corresponding similarity score indicating a degree of similarity based upon the first vector and the respective second vector; and
identifying the first set based upon the one or more similarity scores.

9. The method of claim 8, wherein the similarity score is a Euclidean Distance score.

10. The method of claim 8, wherein identifying the first set based upon the one or more similarity scores comprises selecting a predetermined number of the user-generated primitive element representations for inclusion in the first set.

11. The method of claim 10, wherein each of the selected user-generated primitive representations correspond to a similarity score indicating a higher degree of similarity than any similarity score corresponding to a user-generated primitive element representation not selected for inclusion in the first set.

12. A computer-implemented method for training a machine learning model to generate an output layout for content, the method comprising:
receiving a training dataset comprising one or more training pairs, each training pair comprising:
training content comprising one or more elements arranged in a layout; and
a synthetic user-generated representation of the layout of the training content;
providing data indicating the synthetic user-generated representation and data indicating the one or more elements of the training content as an input to a machine learning model to generate the output layout for the content;
computing a loss value based upon the output layout for the content and data indicating the layout of the training content; and
updating one or more parameters of the machine learning model based upon the loss value.

13. The method of claim 12, wherein providing the data indicating the one or more elements of the training content as the input to the machine learning model comprises:
determining an element input data item for each of the one or more elements of the training content based upon the data indicating the one or more elements; and
generating the input to the machine learning model by randomly ordering the one or more element input data items in the input.

14. A computer-implemented method for generating an output layout for content, the method comprising:
receiving one or more elements for the content;
receiving a user-generated representation of a layout for the content; and
providing, as input to a machine learning model, data indicating the one or more elements for the content and data indicating the user-generated representation of the layout to generate the output layout for the content.

15. The method of claim 14, further comprising:
generating, based upon the output layout and the one or more elements for the content, the content.

16. The method of claim 14, further comprising:
receiving an instruction indicating one or more properties for the layout of the content; and
wherein generating the output layout using the machine learning model is further based upon the instruction indicating the one or more properties.

17. A computer-implemented method for evaluating performance of a machine learning model, the method comprising:
receiving evaluation content, the evaluation content comprising one or more first elements arranged in a first layout;
generating, using the machine learning model, an output layout for content comprising one or more second elements arranged in a second layout;
generating a first sequence of tokens based upon a logical order of the one or more first elements in the evaluation content, wherein the first sequence of tokens comprises a token for each of the one or more first elements;
generating a second sequence of tokens based upon a logical order of the one or more second elements in the content, wherein the second sequence of tokens comprises a token for each of the one or more second elements;
computing a similarity score based upon the first sequence of tokens and the second sequence of tokens; and
generating an evaluation metric for the machine learning model based upon the similarity score, the evaluation metric indicating the performance of the machine learning model.

18. The method of claim 17, further comprising:
determining an X-coordinate and a Y-coordinate for each of the one or more first elements in the evaluation content;
determining a token corresponding to each of the one or more first elements in the evaluation content;
determining the logical order of the one or more first elements based upon the X-coordinates and Y-coordinates for each of the one or more first elements;
wherein generating the first sequence of token based upon the logical order of the one or more first elements comprises ordering the one or more tokens corresponding to each of the one or more first elements in the evaluation content according to the logical order of the one or more first elements;
determining an X-coordinate and a Y-coordinate for each of the one or more second elements in the content;
determining a token corresponding to each of the one or more second elements in the content;
determining the logical order of the one or more second elements based upon the X-coordinates and Y-coordinates for each of the one or more second elements; and
wherein generating the second sequence of token based upon the logical order of the one or more second elements comprises ordering the one or more tokens corresponding to each of the one or more second elements in the content according to the logical order of the one or more second elements.

19. A computing system comprising:
one or more computers; and
one or more non-transitory computer-readable media storing computer-readable instructions configured to cause the one or more computers to perform operations for generating a training dataset, the operations comprising:
receiving content comprising one or more elements;
generating an element representation for each of the one or more elements by processing the content and one or more user-generated primitive element representations;
generating a synthetic user-generated representation of the one or more elements based upon the one or more user-generated primitive element representations and the layout of the one or more elements in the content; and
generating the training dataset based upon the synthetic user-generated representation and the content.

20. One or more non-transitory computer-readable media storing computer-readable instructions configured to cause one or more computers to perform operations for generating a training dataset, the operations comprising:
receiving content comprising one or more elements;
generating an element representation for each of the one or more elements by processing the content and one or more user-generated primitive element representations;
generating a synthetic user-generated representation of the one or more elements based upon the one or more user-generated primitive element representations and the layout of the one or more elements in the content; and
generating the training dataset based upon the synthetic user-generated representation and the content.
